(19) United States
(12) Patent Application Publication
(10) Pub. No.: US 2013/0007034 A1
(43) Pub. Date: Jan. 3, 2013

(54) METHOD FOR AUTOMATICALLY GENERATING ANALYTICAL REPORTS OF PATENT BIBLIOGRAPHIC DATA AND SYSTEM THEREOF

(76) Inventors: Shih-Chun Lu, Taipei (TW); Shih-Hung Lin, Taipei (TW); Shengfu Lin, Taipei (TW)

(21) Appl. No.: 13/170,252

(22) Filed: Jun. 28, 2011

(51) Int. Cl. G06F 17/30

(52) U.S. Cl. 707/769; 707/E17.014

(57) ABSTRACT

A method for generating analytical reports of patent bibliographic data includes: a statistical step for patent bibliographic data, which implements statistical investigation on patent bibliographic data of specific patents; an analytical step for the patent bibliographic data, which analyzes the statistical results from the aforesaid statistical step; wherein the method further includes a reports-generating step, which converts the analytical results into analytical reports; and the statistical step, the analytical step, and the reports-generating step are automatically generated by an automated apparatus. The invention also includes an automatic system for generating analytical reports of patent bibliographic data, and a computer storage medium for storing application commands for automatically generating analytical reports of patent bibliographic data.

### FIELD OF THE INVENTION

The invention relates to a method for automatically generating analytical reports of patent bibliographic data, a system thereof, and a computer storage medium for storing application commands for automatically generating analytical reports of patent bibliographic data, and more particularly to a method for automatically generating analytical reports of patent bibliographic data in one or more languages, a system thereof, and a computer storage medium for storing application commands for automatically generating analytical reports of patent bibliographic data in one or more languages.

### DESCRIPTION OF PRIOR ART

Although software applications that uses computers for statistically investigating the patent bibliographic data are available currently, such as:
1. the software PatentGuider from LearningTech Corp. of Taiwan, refer to http://www.ltc.tw/products/pg/pg_function.aspx;
2. the software GPSA from APIP, refer to http://www.apipa.org.tw/;
3. the software Patent Pilot from the company Apex Information of Taiwan, refer to http://www.patentpilot.com.tw/;
4. the software Analyzer from LexisNexis®, refer to http://corporate.lexisnexis.com/analyzer;
5. the software Metheo Patent from Matheo-Software, refer to http://www.matheo-software.com/; and
6. the software Aureka 9.2 from Thomson Scientific Inc. of U.S., refer to http://aureka.micropat.com/7w/html/applications/online_help/themepublisher_help/index.htm;

But the above-mentioned software is only capable of statistical investigations, and not only lacking in analytical features, but also without the ability of automatically generating analytical reports. In the patent TW-200705221 (which is the equivalence of US-20080172266 and CN-200610144976.1), the inventors of the present invention disclose a “Method for Automatically Analyzing Patent Bibliographic Data and Apparatus Thereof”. Although the method and the apparatus can automatically analyze patent bibliographic data, they still encounter problems in terms of automatically generating analytical reports with discussions, conclusions, and/or recommendations.

Generally speaking, an analytical report of patent bibliographic data not only includes statistical results, but also discussions thereof, and it is also preferable to include conclusions and/or recommendations therein. Therefore, the following difficulties arise in attempting to automatically complete a more comprehensive analytical report of patent bibliographic data:

1. It is critical to have the ability to carry out integrated analyses and investigations on a large volume of patent bibliographic data and statistical analysis tables. But for the patent statisticians nowadays, although they are able to carry out analyses on a single or a few statistical tables of patent bibliographic data, they generally lack the experience of carrying out integrated analyses on a large volume of patent bibliographic data (such as tens or even hundreds of statistical tables of patent bibliographic data). Because human analysis usually involves only a small number of statistical tables of patent bibliographic data (usually no more than 30). Therefore, the inventors had used the method of the aforesaid TW-200705221 to statistically analyze many cases of patent bibliographic data. Because the method can be used to automatically complete statistical calculations and analyses on hundreds (or even thousands) of patent bibliographic data in several minutes, the inventors had used this method to carry out a large number of statistical analyses on each of the cases, and then do an integrated analysis on the resulted large volume of statistical tables. The subsequent integrated analysis from the large volume of statistical tables of patent bibliographic data are further discussed and investigated afterwards. After summarizing the discussions and investigations, the inventors had proposed an automated method thereof, as referred to later.

2. It is critical to automatically convert information resulted from integrated analyses and investigations on a large volume of statistical tables of patent bibliographic data, into contents of an analytical report. For example, when one attempts to investigate and produce an integrated analysis on 100 tables of historic patent numbers and another 100 tables of patent technology life cycles, it becomes difficult to analyze everything as a whole, and hard to automatically convert the relevant results into an analytical report. Things like how to classify the hundreds of tables of historic patent numbers and tables of patent technology life cycles into particular fields of invention, countries, and applicants, and how to clearly produce such details on the analytical report become complicated, because such details are unknown before doing any statistical analyses. In other words, the automated statistical system and the agent or person about to do a statistical analysis has absolutely no clues about such details beforehand. Therefore, the invention has proposed a solution in the paragraphs below.

3. After carrying out integrated analyses and investigations on a large volume of statistical tables of patent bibliographic data, it is vital to have the ability to also provide conclusions and/or recommendations thereof. It is a common problem that patent statisticians generally lack the experience of doing integrated analysis on a large volume of data (as mentioned in point (1) above), so the inventors had utilized the method of TW-200705221 to try to get such experiences in providing conclusions and recommendations for a large volume of statistical tables of patent bibliographic data. Moreover, the inventors had proposed an automated method after summarizing the experiences.

4. After doing integrated analyses, investigations and summarizing on a large volume of statistical tables of patent bibliographic data, thereby obtaining information like conclusions and/or recommendations, it is vital to be able to automatically convert such information into contents of an analytical report. Similar to point (2) above, the conclusions and/or recommendations are unknown before doing any statistical analysis, i.e. the automated statistical system and the agent or person about to do a statistical analysis has absolutely no clues about them beforehand. So it is impossible to know what types of conclusions and/or recommendations will be generated. Therefore, it is also crucial to solve the problem of how to convert the conclusions and/or recommendations into analytical reports after doing analyses, investigations, and summarizing. The invention has proposed a solution in the paragraphs below.

5. To allow the analytical report to be automatically generated in the language preferred by users, such as Chinese, English, Japanese, German, French . . . etc. The invention has proposed a solution as follows.

### SUMMARY OF THE INVENTION

An objective of the invention is to provide a method for automatically generating analytical reports of patent bibliographic data.

Another objective of the invention is to provide a system for automatically generating analytical reports of patent bibliographic data.

Yet another objective of the invention is to provide a computer storage medium for storing application commands for automatically generating analytical reports of patent bibliographic data.

Yet another objective of the invention is to provide a method for automatically generating analytical reports of patent bibliographic data, which is accomplished by using a statistical step of patent bibliographic data, an analytical step of patent bibliographic data, and a reports-generating step.

Yet another objective of the invention is to provide a system for automatically generating analytical reports of patent bibliographic data, which is accomplished by using a statistical step of patent bibliographic data, an analytical step of patent bibliographic data, and a reports-generating step.

Yet another objective of the invention is to provide a computer storage medium for storing application commands comprising a statistical step, an analytical step, and a reports-generating step for patent bibliographic data to automatically generate analytical reports thereof.

Still another objective of the invention is to provide a method for allowing analytical reports of patent bibliographic data to be automatically generated in one or more languages preferred by users.

Still another objective of the invention is to provide a system for allowing analytical reports of patent bibliographic data to be automatically generated in one or more languages preferred by users.

A further objective of the invention is to provide a computer storage medium for storing application commands for allowing analytical reports of patent bibliographic data to be automatically generated in one or more languages preferred by users.

### BRIEF DESCRIPTION OF DRAWINGS

FIG. 1 shows the execution flowchart according to a preferred embodiment of the invention.

FIG. 2 shows an example of the step 110 according to the preferred embodiment of the invention from FIG. 1.

FIG. 3 shows an example of the step 120 according to the preferred embodiment of the invention from FIG. 1.

FIG. 4 shows an example of the step 130 according to the preferred embodiment of the invention from FIG. 1.

FIG. 5 shows an example of the step 140 according to the preferred embodiment of the invention from FIG. 1.

FIG. 6 shows an example of the step 150 according to the preferred embodiment of the invention from FIG. 1.

FIG. 7 shows the execution flowchart according to another preferred embodiment of the invention.

FIG. 8 shows an example of the step 220 according to the preferred embodiment of the invention from FIG. 7.

FIG. 9 shows an example of the step 230 according to the preferred embodiment of the invention from FIG. 7.

FIG. 10 shows an example of the step 240 according to the preferred embodiment of the invention from FIG. 7.

FIG. 11 shows an example of the step 250 according to the preferred embodiment of the invention from FIG. 7.

FIG. 12 shows an example of the step 260 according to the preferred embodiment of the invention from FIG. 7.

FIG. 13 shows the execution flowchart according to a further preferred embodiment of the invention.

FIG. 14 shows a flowchart for evaluating the rationality of patent statistical analyses according to the invention.

FIG. 15 shows a flowchart for evaluating the rationality of integrated analytical results according to the invention.

### DETAILED DESCRIPTION OF PREFERRED EMBODIMENTS

The method for automatically generating analytical reports of patent bibliographic data comprises:

a statistical step for patent bibliographic data, which implements statistical investigation on patent bibliographic data of specific patents;

an analytical step for the patent bibliographic data, which analyzes statistical results from the aforesaid statistical step;

characterized in that:

further comprising a reports-generating step, which converts the statistical and/or analytical results into analytical reports; and

the statistical step, the analytical step, and the reports-generating step are automatically generated by an automated apparatus.

The aforesaid statistical step of patent bibliographic data refers to implementing statistics on specific patent pools, wherein the patent pools may be all of the published applications and/or issued patents from one or more particular countries or regions (for instance, when doing industrial analysis on a particular country, the bibliographic data from all of the published applications and/or issued patents in the country is analyzed), or any specific patent pools obtained from patent retrievals. In which retrievals may be automatic (e.g. via a computer) retrievals (such as monitored patent retrievals on a regular basis), manual retrievals, or mixed retrievals (combination of automatic and manual). The aforesaid specific patent pools refer to patent pools obtained from one or more patent retrievals, or from further automatic selections and/or manual selections of said patent pools.

Items involved in said statistical step may be patent bibliographic data regularly used or occasionally used in the software available commercially, such as patent numbers (which include application numbers, publication numbers, issue numbers, patent certificate numbers . . . etc), inventors, applicants, assignees, nationalities of the inventors, nationalities of the applicants, application dates, published dates, issue dates, IPC classifications, other classifications (such as UPC, EC, F-term, Locarno Classification, and customized classifications), cited patents (including forward citations, backward citations, and cited references from search reports), other cited literatures (including cited articles, books, and reports), related patent information (such as divisional applications, priorities, CTP (Continuation-In-Part) applications, and CP (Continuation of Application) applications); the usage of said patent bibliographic data herein mainly resembles that of the commercial software. The word “resembles” means that the inventors had significantly increased the items for statistical investigation, and yet the items are still mostly used in the same way as in the commercial software. For example, the IPC is further divided into overall classifications, primary classifications, and secondary classifications, as can be referred to in the descriptions of statistical tables below. However, methods used to produce and analyze tables mainly resemble that for producing and analyzing IPC tables in the commercial software.

In said statistical step of patent bibliographic data, the items included for statistical investigation may also be the patent bibliographic data rarely used in the commercial software, such as patent agents (attorneys), patent reviewers, legal status (whether an application is being processed, granted, rejected, appealed, in administrative proceedings, licensed, assigned . . . etc), titles of the inventions, abstracts, and claims (please refer to ThemeScape Map of Aureka 9.2). The usage of said patent bibliographic data mainly resembles that of the commercial software.

In said statistical step of patent bibliographic data, the items may also be the patent bibliographic data that have not been used in the statistical software for bibliographic data available commercially, such as the primary IPC classifications, the secondary IPC classifications, the primary UPC classifications, the secondary UPC classifications, and so on; or a plurality of statistical items may be combined, such as combining the IPC classifications and titles of the inventions, abstracts, claims, so as to use technical key words and/or field key words for generating statistical results as a statistical analysis basis for deciding technical relevance, patent types, and/or patent subject matters thereof. The related details may be referred to in the aforesaid patent application of the inventors. Said key words above refer not only to key words, but also to key phrases, and/or key clauses.

Said tables obtained from statistical investigation may be previously known tables of patent bibliography, for example:
(1) The tables of all types of patents, including tables of historical patent numbers, tables of patent technology life cycles, each of the patent classifications (IPC, UPC, EC, F-term, Locarno Classification, and customized classifications), tables of patent numbers (and/or percentage), tables of patent numbers from different countries (and/or percentage), tables of patent numbers from different applicants (and/or percentage), and tables of patent numbers from different inventors (and/or percentage).
(2) Tables of important countries, and the important countries are the ones having top-ranking patent numbers in point (1) mentioned above. For the important countries, this includes tables of historical patent numbers, tables of patent technology life cycles, tables of patent numbers according to different patent classifications (and/or percentage), tables of patent numbers from different applicants (and/or percentage), tables of patent numbers from different inventors (and/or percentage), and technical analyses of important patents.
(3) Tables of important assignees, and the important assignees are the ones having top-ranking patent numbers in point (1) mentioned above. For the important assignees, this includes tables of historical patent numbers, tables of patent numbers according to different patent classifications (and/or percentage), tables of patent numbers from different inventors (and/or percentage), tables of historical inventors (like total number of inventors, new inventors, and previous inventors), and tables of (historical) ranking.
(4) Tables of the important patent categories (IPC, UPC, EC, F-term, Locarno Classification, and customized classifications), and the important patent categories (or classifications) are the ones having top-ranking patent numbers in point (1) above. For the important patent classifications, this includes tables of historical patent numbers, tables of technology life cycles, tables of patent numbers from different countries (and/or percentage), tables of patent numbers from different assignees (and/or percentage), and tables of patent numbers from different inventors (and/or percentage).
(5) Tables of important inventors, and the important inventors are the ones having top-ranking patent numbers in point (1) above. For the important inventors, this includes tables of historical patent numbers, and tables of patent classifications.
(6) Citation analysis tables, tables having total citation analysis, tables of cross-citation analysis for the important assignees, tables of self-citation analysis for the important assignees, tables of other citation analysis for the important assignees, tables of important citation-tree analysis, tables of forward citations, tables of backward citations, and tables of two-way citation analysis.

Said tables obtained from statistical investigation may also be tables of patent bibliography that are less frequently used, rarely used, or the ones originally invented by the inventors, for instance:

1. Tables of primary patent classifications (IPC, UPC, EC, F-term, Locarno Classification, and customized classifications), and the primary patent classifications are the ones ranked first among patent classifications. For all of the primary patent classifications, this includes tables of patent numbers (and/or percentage), tables of historical patent numbers, tables of technology life cycles, tables of patent numbers from different countries (and/or percentage), and tables of patent numbers from different inventors (and/or percentage). And this may further include more advanced tables, such as for specific primary patent classifications and specific countries, tables of historical patent numbers, tables of technology life cycles, tables of historical patent numbers for specific assignees, tables of historical inventors for specific important assignees (like total number of inventors, new inventors, and previous inventors), and tables of (historical) ranking for specific important assignees.

2. Tables of secondary patent classifications (IPC, UPC, EC, F-term, Locarno Classification, and customized classifications), and the secondary patent classifications refer to the ones not ranked first among patent classifications. For all of the secondary patent classifications, this includes tables of patent numbers (and/or percentage), tables of historical patent numbers, tables of technology life cycles, tables of patent numbers from different countries (and/or percentage), and tables of patent numbers from different inventors (and/or percentage). And this may further include more advanced tables, such as for specific secondary patent classifications and specific countries, tables of historical patent numbers, tables of technology life cycles, tables of historical patent numbers for specific assignees, tables of historical inventors for specific important assignees (like total number of inventors, new inventors, and previous inventors), and tables of (historical) ranking for specific important assignees.

3. Advanced tables of important countries, and the important countries are the ones having top-ranking patent numbers in (1) related to previously known tables described above. For the important countries, this includes tables of historical patent numbers and/or technology life cycles for specific patents classifications, tables of specific historical patent numbers, and technical analyses of important patents.

4. Similarly, advanced tables of important applicants, inventors, and patent classifications may also be included.

Said statistical step may comprise individual statistical methods that employ any previously known methods or tools for automatically doing statistics, as can be referred to in TW 200705221.

Said analytical step can at least individually analyze each of the statistical results from the statistical step; is preferably further comprised of a secondary step of integrated analyses or discussions; is more preferably further comprised of secondary steps of integrated analyses and discussions; is most preferably able to combine the secondary steps of integrated analyses and discussions into one single step.

Said secondary step of integrated analyses is used to combine multiple analytical results into a discussion group, and do statistics/analyze similarity of the multiple analytical results of the group; said secondary step of discussions is used to discuss results from integrated statistics/analyses, so as to obtain a basis for discussions, conclusions, and/or recommendations of the analytical reports.

Said analytical step may employ any previously known methods or tools for automatically doing statistical analyses, including the method and the system described in TW 200705221.

Reports generated from said reports-generating step may include at least either one of the statistical results, analytical results, integrated analyses, discussions, conclusions, and recommendations.

Said statistical results refer to results from automatic statistical investigation of bibliographic data, and have statistical meanings. Said analytical results refer to analyses of results from automatic statistical investigation of bibliographic data having statistical meanings.

Said integrated analyses and discussions refer to integrating multiple related analytical results and subsequently analyzing the results. For instance, methods of simple totaling or weighted statistics may be used to analyze the match levels of the related analytical results, thereby determining results of the integrated analyses, as can be referred to the embodiment below. Said conclusions are selected from results of said integrated analyses and discussions which have statistical meanings and/or importance, as can be referred to the embodiment below. Said recommendations are selected from results of said integrated analyses and discussions and/or the conclusions which have statistical meanings and are relatively important to people who require the reports, as can be referred to the embodiment below.

The reports generated from said reports-generating step may be further comprised of more contents such as brief introductions, so as to explain meanings and/or purposes of each of the statistics/analyses.

The reports generated from said reports-generating step is preferably comprised of conclusions and/or recommendations (better to be comprised of both), is more preferably further comprised of integrated analyses and discussions, is even more preferably further comprised of statistical and/or analytical results, and is most preferably further comprised of brief introductions.

The reports-generating step preferably comprises a secondary step of completing contents of statistics/analyses, which combines results from the analytical step for the patent bibliographic data to form contents of statistics/analyses in the analytical reports. The secondary steps of completing contents of statistics/analyses, integrated analyses and discussions are executed by an automated apparatus.

Said statistical step, analytical step, and reports-generating step may be carried out in consecutive order, in parallel order, in cross order, in mixed order, or in any ways previously known to the software industry, and is preferably carried out in the way described in the diagrams and descriptions thereof below.

Said automated apparatus refer to any previously known automated apparatuses, as can be referred to in TW 200705221, and is preferably a computer.

Said automatically generated reports may be defaulted to one or more languages, or configured to be in one or more languages before/during/after executing the method of the invention. In which the language selected may be any languages recognized by WIPO, such as Chinese (Traditional), Chinese (Simplified), English, Japanese, German, Italian, Spanish . . . etc. The proposed solutions are described below.

Said items (targets/headings/subjects) resulted from the aforesaid statistics, analyses, discussions, conclusions, and recommendations are unknown beforehand; is difficult to find out and clearly label afterwards. These are the problems the related industry has been unable to solve effectively so far, and the inventors of the present application have proposed the following solutions thereto:

1. For the first layer of statistics/analyses of bibliographic data, such as the statistics/analyses of total historical patent numbers, technology life cycles, patent numbers in technology-owned countries, IPC patent numbers . . . etc, label them respectively as:

(1) statistics/analyses of total historical patent numbers for XX

(2) statistics/analyses of technology life cycles for XX

(3) statistics/analyses of patent numbers in technology-owned countries for XX

(4) statistics/analyses of patent numbers for XX using total three-level IPC

(5) statistics/analyses of patent numbers for XX using primary three-level IPC

(6) statistics/analyses of patent numbers for XX using secondary three-level IPC

(7) statistics/analyses of patent numbers for XX using total four-level IPC

(8) statistics/analyses of patent numbers for XX using primary four-level IPC

(9) statistics/analyses of patent numbers for XX using secondary four-level IPC

(10) XX . . . .

Excluding XX, all of the above-mentioned items are default for statistical analysis in the system, and are marked with default serial codes. XX is unknown before doing any statistics, and remains as XX before users input any relevant information. After the users input the information, the system automatically replaces “XX” with the inputted information. For example, a table was marked as “table of total historical patent numbers for XX”, and would be automatically replaced as “table of total historical patent numbers for RF technology” once “RF technology” is inputted. If no relevant information of XX was inputted after completing statistics, analyses, discussions, conclusions, and recommendations, or if errors were inputted, the system would remind the users to input relevant information of XX. The system would automatically replace “XX” with the inputted information if the users had inputted information as required, or automatically replace “XX” with a code if no information was inputted. The code may be fixed or changeable, and is preferably changeable. The more preferable code comprises dates, and/or patent names, and/or important key phrases in abstracts.

2. Based on the results from the first layer of statistics/analyses, when analyzing the important countries for the second layer of statistics/analyses of bibliographic data, how to find out how many important countries there are? And how to tell apart each of the important countries CN1 (Country 1), CN2 (Country2) . . . etc? This can be found out clearly after analyzing patent numbers from different countries at the first layer of statistics/analyses. For instance, if there were 12 important countries sequentially listed as CN1(US), CN2(DE), and CN3(JP) . . . etc. Generally, the first layer of statistics/analyses is preferably connected to the second layer of statistics/analyses in one of the four methods mentioned below:
(1) After analyzing the important countries at the first layer of statistics/analyses, the second layer of statistics/analyses for each of the important countries is carried out immediately, such that information like the number and the order of the important countries can be immediately passed on.
(2) After analyzing the important countries at the first layer of statistics/analyses, the number and the order of the important countries are immediately stored in a computer memory, and said information is retrieved from the computer memory when the second layer of statistics/analyses for the important countries is starting.
(3) After analyzing the important countries at the first layer of statistics/analyses, the number and the order of the important countries are immediately stored in a specific file, and said information is retrieved from the specific file when the second layer of statistics/analyses for the important countries is starting.
(4) After analyzing the important countries at the first layer of statistics/analyses, the number and the order of the important countries are immediately stored in a report, and said information is retrieved from the report when the second layer of statistics/analyses for the important countries is starting.
   Anyone of ordinary skill in the art may use any mixed methods, modified methods, or similar methods based on the four methods described above. In addition, other items (targets/headings/subjects) of the second layer of statistics/analyses may be resolved by using similar methods, for example:
(5) CN1 for XX . . . .
   Excluding XX and CN1, other items are default for statistical analysis in the system, and are marked with default serial codes; the marking of XX has been described above; CN1 can be found out from the first layer of statistics. For instance, if countries were ranked in terms of patent numbers in the order of the U.S. (US), Japan (JP), Germany (DE) . . . , then the system would automatically convert said CN1 in the total historical patent numbers, technology life cycles, total three-level IPC patent numbers, primary three-level IPC patent numbers, secondary three-level IPC patent numbers . . . , into the U.S. (US). After completing the statistics/analyses of said CN1 (US), the statistics/analyses for CN2 and CN3 . . . etc. would also be done sequentially, and the system would then automatically convert CN2, CN3 . . . etc. into Japan (JP), Germany (DE) . . . etc.
Similarly, the second layer of statistics/analyses for results of IPC patent numbers, assignee patent numbers . . . etc derived from the first layer of statistics/analyses can be resolved by using methods resembling the aforesaid method.

3. Methods for carrying out further analyses like the third and fourth layer of statistics/analyses may be based on the aforesaid methods.

Said targets resulted from the aforesaid statistics, analyses, discussions, conclusions, and recommendations are unknown beforehand and need to be clearly labelled afterwards. These are the problems the related industry has been unable to solve effectively so far, and the inventors have proposed the following solutions thereto:
1. The first layer of statistics/analyses of bibliographic data can be referred to in the aforesaid descriptions.
2. For the second layer of statistics/analyses of bibliographic data, these are the second layer of statistics/analyses on results like patent numbers owned by different countries from the first layer of statistics/analyses, such as the statistics/analyses of total historical patent numbers, technology life cycles, IPC patent numbers for CN1 (Country 1), CN2 (Country 2) . . . etc. for XX. Using CN1 as an example, the statistics/analyses are respectively labelled as:

(1) statistics/analyses of total historical patent numbers of XX for CN1

(2) statistics/analyses of technology life cycles of XX for CN1

(3) statistics/analyses of patent numbers of XX for CN1 using total three-level IPC

(4) statistics/analyses of patent numbers of XX for CN1 using primary three-level IPC

(5) statistics/analyses of patent numbers of XX for CN1 using secondary three-level IPC

(6) CN1 of XX . . . .

Excluding XX and CN1, other items are default for statistical analysis in the system, and are marked with default serial codes; the marking of XX has been described above; CN1 can be found out from the first layer of statistics. For instance, if countries were ranked in terms of patent numbers in the order of the U.S. (US), Japan (JP), Germany (DE) . . . , then the system would automatically convert the CN1 in the statistics/analyses of total historical patent numbers, technology life cycles, total three-level IPC patent numbers, primary three-level IPC patent numbers, secondary three-level IPC patent numbers . . . into the U.S. (US). After completing the statistics/analyses of said CN1 (US), the statistics/analyses for CN2 and CN3 . . . etc. would also be done sequentially, and the system would then automatically convert CN2, CN3 . . . etc. into Japan (JP), Germany (DE) . . . etc.

Similarly, the second layer of statistics/analyses for results of IPC patent numbers and assignee patent numbers . . . etc. derived from the first layer of statistics/analyses can be resolved by using methods resembling the aforesaid method.
3. For the third layer of statistics/analyses of bibliographic data, such as when statistics/analyses are carried out on each of the three-level IPC classifications for the U.S. (US) from the second layer, because it is already known from the second layer of statistics/analyses that the U.S. patent pool has the three-level IPC classifications in the order of IPC1 (A61k), IPC2 (C12N), . . . etc.; when the third layer of statistics/analyses is being carried out, the system automatically converts IPC1, IPC2 . . . etc. into A61K, C12N . . . etc.
4. Methods for carrying out further analyses like the fourth and fifth layer of statistics/analyses may be based on the aforesaid methods.

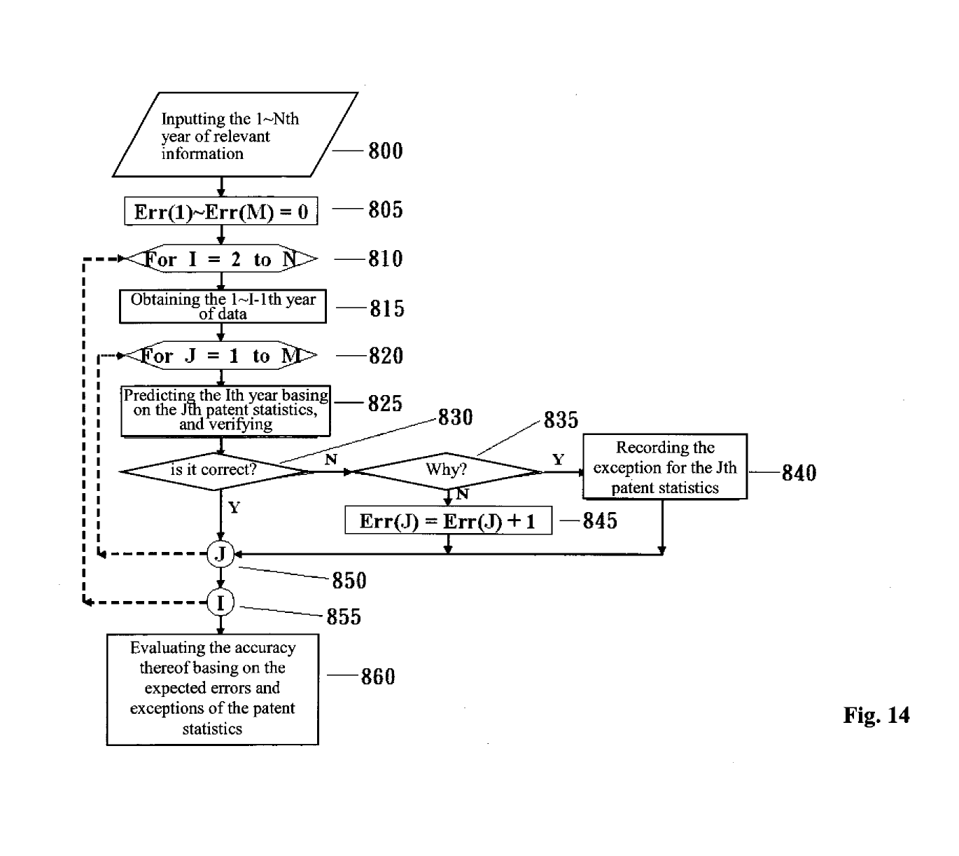

Do the statistical results from the aforesaid statistical step have any meanings? Are the analyses made from the statistical results reasonable? Are the integrated analyses and discussions made from the analytical results reasonable? Are the conclusions made from the results of integrated analyses and discussions reasonable? Are the recommendations made from the results of integrated analyses and discussions reasonable? All of these are issues still waiting to be better addressed by the industry, and the inventors have proposed a solution based on a method of statistics-prediction-comparison in response, as can be referred to in FIG. 14 and descriptions thereof.

In addition, the industry has also been trying to solve the issue of generating brief introductions for the aforesaid reports, and the inventors have also proposed a method in attempting to solve this issue, which is described below. However, the method is only one of the possible ways to solve the issue, and is not to be used to limit the scope of the invention.

Brief introductions for the aforesaid reports are generally comprised of: at least one of technical fields, patent database categories, statistics-analyses categories, and/or statistics-analyses methods, and is preferably comprised of a plurality of said fields/categories/methods; is more preferably comprised of all of said fields/categories/methods, and is most preferably further comprised of relevant information (such as a brief description of report contents). Said technical fields, patent database categories, statistics-analyses categories, and/or statistics-analyses methods are automatically generated according to inputted information, files names from patent pools, and/or statistical results of relevant contents, as explained below; but can also be partially and manually modified if necessary.

Said “technical fields” in the brief introductions are preferably named directly from inputted information, files names from patent pools, or statistical results of key words; is more preferably named directly from inputted information or files names from patent pools, and is most preferably named directly from inputted information. For instance, if a patent pool has a file name of “LED technology”, or the inputted information of the technical field is “LED technology”, then the technical field of a report thereof is automatically generated as follows:
This report is a statistical report of bibliographic data related to “LED technology”.
   Said “patent database categories” in the brief introductions are preferably named directly from inputted information, patent numbers from files of patent pools (including country and database codes), bibliographic data originated from the patent numbers, and/or statistical results; is more preferably named directly from inputted information or patent numbers from files of patent pools (including country and database codes). For example, if the inputted information was “USPTO, EPO”, then the patent database categories of a report thereof are automatically generated as follows:
Retrieved databases include “USPTO, EPO”.

Said “statistics-analyses categories” in the brief introductions may be any of previously known statistics-analyses of bibliographic data, and/or statistics-analyses of bibliographic data created by the inventors; these are generally divided into analyses of total patent numbers, historical patent numbers, technology life cycles, citation relationships, countries, companies, technologies, and others (such as analyses of inventors). Using the analyses of total patent numbers as an example, these include the analyses of countries of major assignees, major assignees, total three-level/four-level/five-level IPC patent classifications, total one-order/two-order UPC patent classifications, primary three-level/four-level/five-level IPC patent classifications, primary one-order/two-order UPC patent classifications, secondary three-level/four-level/five-level IPC patent classifications, secondary one-order/two-order UPC patent classifications . . . etc., then the following contents are automatically generated, wherein explanations for each of the statistical analyses are written beforehand. If certain analyses were found to have no statistical meanings, the system may automatically or passively (depending on options, for example) delete the related statistical items and explanations if needed, or these may be deleted afterwards; these are preferably deleted automatically or passively by the system; are more preferably automatically deleted by the system.

Analyses of countries where major assignees originate:
Enumerating patent numbers obtained by different countries, so as to analyze each of the countries' potential for a technology.
   Analyses of major assignees:
Enumerating patent numbers obtained by different assignees, so as to analyze each of the assignees' potential for a technology.
   Analyses of total three-level/four-level/five-level IPC patent classifications:
Enumerating patent numbers for each of the IPC patent classifications, so as to analyze the overall main technologies for each of the IPC patent classifications.
   Analyses of primary three-level/four-level/five-level IPC patent classifications:
Enumerating patent numbers for each of the IPC patent classifications, so as to analyze the main core technologies for each of the IPC patent classifications.
   Analyses of secondary three-level/four-level/five-level IPC patent classifications:
Enumerating patent numbers for each of the IPC patent classifications, so as to analyze the derived/peripheral technologies for each of the IPC patent classifications.
   . . . (omitted)

For said “statistics-analyses methods” in the brief introductions, the system may produce flowcharts thereof according to the default procedures of each type of statistics-analyses, and then list the pre-written procedure descriptions thereafter. If certain analyses were found to have no statistical meanings, the system may automatically or passively (depending on options, for example) delete the related statistical methods if needed, or have them deleted manually afterwards; these are preferably deleted automatically or passively by the system; are more preferably automatically deleted by the system.

Problems like how to automatically execute the statistical results from the aforesaid reports and how to present them in particular formats have been troubling the industry for a long time. Wherein said automatic execution can be referred to in the following flowcharts, descriptions, and embodiments thereof, as well as in TW 200705221. For instance, the presentation formats for statistical results may be defaulted as:
BB of AA field
CC . . . .
DD.

Wherein information for the AA field comes from the information inputted before executing files; BB is the name of a statistical item (please refer to the paragraphs above about how to obtain it); CC . . . is a table obtained from an analysis; DD . . . is a statistical result thereof, and DD . . . might be:
The field of LED technology belongs to the “initial growth period”.

Problems like how to automatically execute and generate contents for the integrated analyses/discussions from the aforesaid reports have also been troubling the industry for a long time, and methods for automatically executing integrated analyses/discussions by modules can be referred to in the following flowcharts, descriptions, and embodiments thereof, as well as in TW-200705221. The inventors have proposed a solution about automatically generating contents for integrated analyses/discussions below: distinguishing possible results for the integrated analyses/discussions from each module in advance, and then produce a description for each of the results in advance. Therefore, when the integrated analyses/discussions have reached one of the possible results, the system will then automatically generate the corresponding contents. For example, the formats for integrated analyses/discussions may be:
DD . . .
BB . . .
CC . . .

Wherein DD . . . is a name from grouping/sub grouping; BB . . . is a table obtained from a (sub) grouping analysis (please refer to the following table); CC . . . is default information retrieved from a “discussion” file according to a result of integrated analyses, such as:

Results of integrated analyses indicate: The life cycle tables are between mid to end of growth period.

Analytical results from each of the life cycle tables are listed in the following table:

| Name of the life | | | |
|---|---|---|---|
| cycle table | Analytical results | Weight ratio | Weighted result |
| Summary life | End of growth period | 1.0 | 3.6 |
| cycle diagram | (3.6) | | |
| ZZ life cycle | Mid growth period | 0.8 | 2.64 |
| diagram | (3.3) | | |
| YY life cycle | Peak period | 0.75 | 3.0 |
| diagram | (4) | | |
| XX life cycle | End of growth period | 0.72 | 2.592 |
| diagram | (3.6) | | |
| WW life cycle | Mid growth period | 0.68 | 2.244 |
| diagram | (3.3) | | |
| VV life cycle | Initial growth period | 0.67 | 2.01 |
| diagram | (3.0) | | |
| . . . | . . . | . . . | . . . |
| Total | Between mid to end of | (4.62) | (16.086) |
| | growth period | | |

From the table above, the values of 3.6, 3.3, 4, 3.6, 3.3, and 3.0 from the second column (Analytical results) are the analytical values of each of the life cycle tables (as in the first column), respectively; the words in the first column are the default words retrieved from the “discussions” files according to the analytical values. The third column (Weight ratio) lists values of 1.0, 0.8, 0.75, 0.72, 0.68, and 0.67, and they are the weight ratios of each of the life cycle tables (as in the first column), respectively. The weighting method may be any previously known ones for enumerating bibliographic data, like the ratio between analytical patent numbers and overall patent numbers. The fourth column (Weighted result) lists values of 3.6, 2.64, 3.0, 2.592, 2.244, and 2.01, which are the products from multiplying said values from the second and the third columns. For the row titled “Total”, 4.62 and 16.08 are the sum from adding together the values from the third column, and from the fourth column, respectively, and 3.48 is the quotient resulted from having 16.08 divided by 4.62; words before 3.48 are the default words retrieved from the “discussions” files according to the value (3.48).

The industry has also been trying to solve the issue of how to generate conclusions for the aforesaid reports. In response, the inventors have proposed a solution in which: the system may automatically generate conclusions according to results of integrated analyses/discussions. For example, the default format of the conclusions may be:
BB . . . , CC . . . of AA.

Wherein AA is a default item for conclusions, or information inputted before executing files (“The technology of AA field” in the following); 138 . . . is a result of integrated analyses (“is currently between mid to end of the growth period, which is still adequate for further researches and developments, and may lead to opportunities of getting technologically advanced than others; the potential profits after achieving successful researches and developments are still high” in the following); CC . . . is default information retrieved from the “conclusion” files (“The technology of AA field is still adequate for further researches and developments, and may lead to opportunities of getting technologically advanced than others; the potential profits after achieving successful researches and developments are still high” in the following) according to the result of integrated analyses, such as:

The technology of AA field is currently between mid to end of the growth period, which is still adequate for further researches and developments, and may lead to opportunities of getting technologically advanced than others; the potential profits after achieving successful researches and developments are still high.

The industry has also been trying to solve the issue of how to generate recommendations for the aforesaid reports. In response, the inventors have proposed a solution in which: the system can automatically generate recommendations according to results of integrated analyses/discussions. For example, the default format of the recommendations may be:
BB . . . , CC . . . of AA.

Wherein AA is a default item for recommendations (“Technologies leading in research and development (R&D) priority list” in the following; BB . . . is a result of integrated analyses (“XX is an emerging technology that is becoming increasingly demanded, so any companies that specialize in XX should consider invest in R&D related to XX as a priority. And companies that are interested in XX and planning to invest in it should put additional emphasis on the related R&D” in the following); CC . . . is default information retrieved from the “recommendation” files (“any companies that specialize in XX should consider invest in R&D related to XX as a priority. And companies that are interested in XX and planning to invest in it should put additional emphasis on the related R&D” in the following) according to the result of integrated analyses, such as:

Technologies leading in research and development (R&D) priority list: XX is an emerging technology that is becoming increasingly demanded, so any companies that specialize in XX should consider invest in R&D related to XX as a priority. And companies that are interested in XX and planning to invest in it should put additional emphasis on the related R&D.

Another problem that has been troubling the industry is how to automatically generate reports in one or more default languages, or configure the reports to be in one or more languages before/during/after executing the method of the invention. In response, the inventors have proposed a solution in which: for all types of the aforesaid default formats, default items that may appear, and/or descriptions (including descriptions of brief introductions, individual statistical results, integrated analyses-discussions, conclusions, recommendations . . . etc.) of the default formats and items that may appear, related contents thereof in different languages are saved as tables in advance. As an example, a part of data generated in Chinese and English is listed below:

| | [symbol] (Chinese) | English |
|---|---|---|
| A1 | [symbol] [symbol] | Results of Various Historical Patent |
| | [symbol] [symbol] | Statistics are listed below and the weighted |
| | [symbol] | value is calculated basing on number of patents: |
| A2 | [symbol] [symbol] | The results of various life cycles is listed in |
| | [symbol] [symbol] | the following table, and the weighted factor is |
| | [symbol] [symbol] | calculated basing on number of patents and assignees: |
| A3 | [symbol] [symbol] | The lower table's statistics is calculated |
| | | basing on the above table: |
| A4 | [symbol] [symbol] | basing on the above table, it's in |
| . . . | . . . | . . . |
| B1 | [symbol] | Sprouting Period |
| B2 | [symbol] | Initial Growth Period |
| B3 | [symbol] | Mid Growth Period |
| B4 | [symbol] | End of Growth Period |
| B5 | [symbol] | Maturing Period |
| B6 | [symbol] | Peak Period |
| B7 | [symbol] | declining period |
| . . . | . . . | . . . |

For instance, basing on “results of various historical patent statistics” and weighted values” (A1), a subsequent result of integrated analysis thereof is “maturing period for the technology” (B5), and if the users chose to have a report in Chinese, then the report would automatically look for the Chinese version of “results of various historical patent statistics are listed below, and the weighted value is calculated based on number of patents:”, then list a statistical table thereafter, and add the Chinese versions of A4 and B5 after the statistical table, which are the words that say “base on the above table, it's in maturing period.” If the users chose to have a report in English, then the report would automatically look for the English version of “results of various historical patent statistics are listed below, and the weighted value is calculated based on number of patents:”, then list a statistical table thereafter, and add the English versions of A4 and B5 after the statistical table, which are the words that say “base on the above table, it's in maturing period.”

The aforesaid format of reports may be any previously known formats, such as paper-based or non paper-based formats (like electronic files). A complete report generated using the method of the invention (including a brief introduction, a statistical/analytical result, an integrated analysis/discussion, a conclusion, and a recommendation) is generally very voluminous. Using the statistics of bibliographic data based on 2000-10000 patents as an example, this would amount to approximately 2000-10000 pages if printed out on papers; using an electronic file like the WORD file as an example, the file size would be approximately 60-300 Mb. Therefore, it is preferable to have the report generated in non paper-based formats (like the electronic files).

Because a complete report is very voluminous, it may also be generated with only parts of the contents. For example, a user may choose which parts of a report to include before/during/after doing statistics, like choosing to include only an integrated analysis/discussion, a conclusion, and a recommendation. As a result, the contents of the report would be significantly reduced, and the resulted file size would be only approximately one-fiftieths to one-two hundredths of a complete report. Another solution is to generate a report by basing on relevancy. For instance, an electronic file may be presented as having just a conclusion and a recommendation first; if a user was interested in one or more other contents like a conclusion and/or recommendations, he may select the conclusion and/or recommendations, or select some of the conclusion and/or recommendations separately, and the system would immediately display relevant integrated analyses/discussions—which are the basis/source for the conclusion and/or recommendations. If the user was interested in one or more statistical results on which the integrated analyses/discussions are based, he/she may select said statistical results, or select some of the statistical results separately, and the system would immediately display the statistical results. The system also allows users to directly select any items of interests at any time, which means that the reports may be included with menus for selecting items, and more particularly hierarchical menus.

Regardless of a report being paper-based or non paper-based, the report may usually also include other items like a completed date (time), execution entity, and consigner (not necessarily present) for the report. However, said items are well known to people of ordinary skill in the art, and thus will not be further described here.

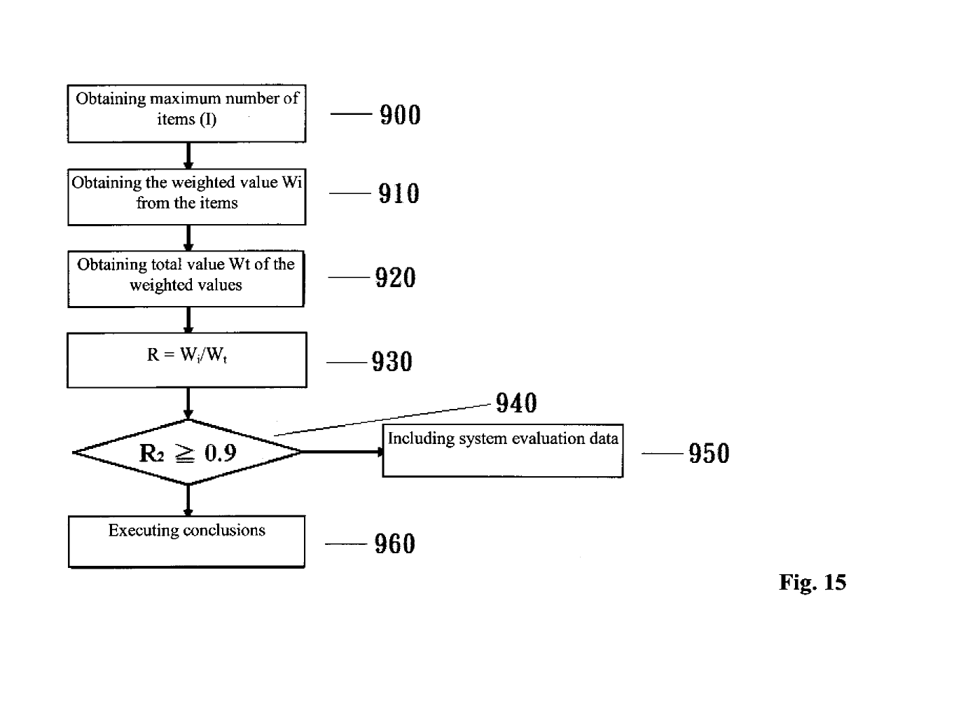

Analyses of the rationality of statistics/analyses can be resolved by using the method described in FIG. 14; please refer to FIG. 14 and descriptions thereof. Analyses of the rationality of integrated analyses/discussions can be resolved by using the method described in FIG. 15; please refer to FIG. 15 and descriptions thereof.

The invention has also disclosed a system for automatically analyzing patent bibliographic data, comprising:
an automated apparatus; and
a software application for automatically analyzing patent bibliographic data, such that said automated apparatus can automatically do statistics/analyses to patent bibliographic data waiting for analysis, and automatically generate analytical reports of patent bibliographic data thereafter;
characterized in that:
the software application includes:
a statistical step, which implements statistical investigation on patent bibliographic data of specific patents;
an analytical step, which analyzes statistical results from said statistical step;
a reports-generating step, which converts the statistical and/or analytical results into analytical reports; and
said statistical step, said analytical step, and said reports-generating step are automatically generated by said automated apparatus.

Wherein the definition of said automated apparatus can be referred to in TW-200705221, and is preferably a computer system.

Each of said steps and preferable conditions thereof can be referred to in the paragraphs above.

The invention has also disclosed a computer storage medium for storing application commands for allowing an automated system to automatically analyze patent bibliographic data, and the application commands allow for automatic analysis of patent bibliographic data by including:
a statistical step, which implements statistical investigation on patent bibliographic data of specific patents;
an analytical step, which analyzes the statistical results from the aforesaid statistical step;
characterized in that:
further comprising a reports-generating step, which converts the statistical and/or analytical results into analytical reports.

Wherein the definition of said automated system can be referred to in TW-200705221, and is preferably a computer system.

Each of said steps and preferable conditions thereof can be referred to in the paragraphs above.

Said computer storage medium may be any of previously known computer storage media, as can be referred to in Wikipedia at the following web addresses: http://en.wikipedia.org/wiki/Category:Computer_storage_media (English version) http://zh.wikipedia.org/zh-tw/Category:%E9%9B%BB%E8%85%A6%E5%84%B2%E5%AD %98%E5%AA %92%E9%AB%94 (Chinese version)

The invention will be better understood when considered in conjunction with the accompanying diagrams, in which:

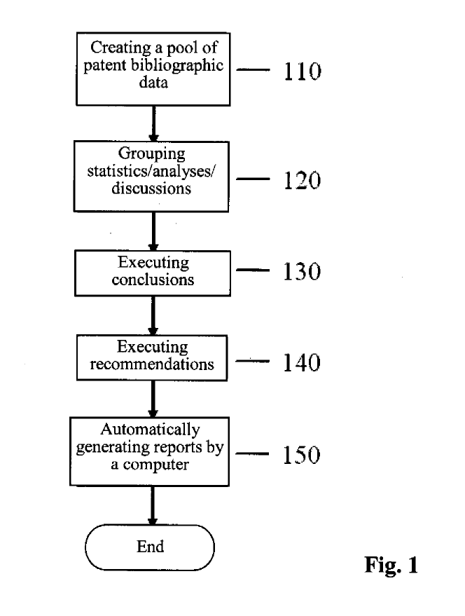

FIG. 1 is the execution flowchart according to a preferred embodiment of the invention, wherein step 110 creates a pool of patent bibliographic data, which are the patents that have been retrieved and selected, and then used to form a pool of patent bibliographic data waiting for statistical analyses after the related bibliographic data is obtained from websites, optical discs, or customized databases, and subsequently temporarily storing the pool in a memory; step 120 carries out grouped statistics, analyses, and discussions on the patent bibliographic data from step 110, and then temporarily stores results thereof in the memory; step 130 makes conclusions from the statistics/analyses/discussions obtained in step 120, and temporarily stores the conclusions in the memory; step 140 makes recommendations from the statistics/analyses/discussions obtained in step 120, and temporarily stores the recommendations in the memory; step 150 arranges a complete report from the statistics/analyses/discussions, conclusions, recommendations temporarily stored in the memory according to inputted information, along with a brief introduction written according to the inputted information and the results of statistics/analyses/discussions thereto.

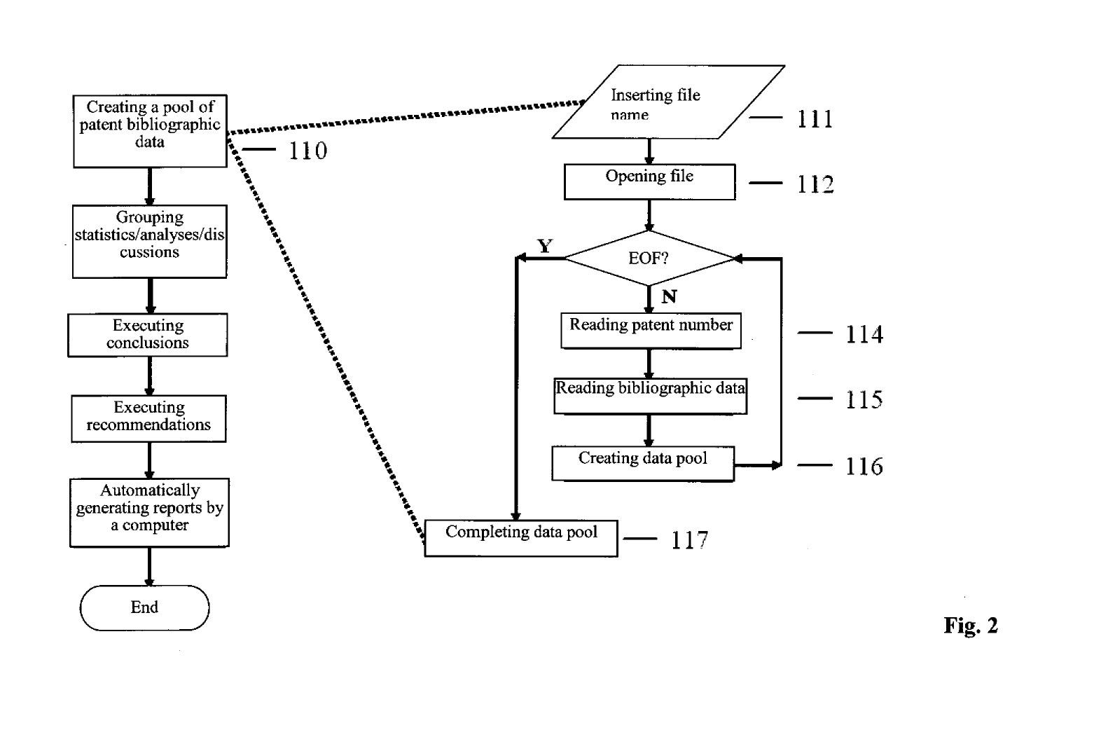

FIG. 2 shows an example of the step 110 according to the preferred embodiment of the invention from FIG. 1. Step 111 allows for manual input of a file name (including a path thereof) for the pool; step 112 opens the file of the pool; step 113 decides if EOF (End of File) was reached, which determines whether the End of File information has been read; if yes, step 110 is finished; if not, steps 114, 115, 116, and 113 are repeatedly executed in this order until step 113 determines EOF has been reached; step 114 reads the patent number; step 115 reads bibliographic data of the patent from a bibliographic database in the system according to the patent number; step 116 loads the bibliographic data for the patent into the pool. The example works better in systems having patent bibliographic databases. In addition, the example also works better for patent pool files having only patent numbers, and for files having partial or complete bibliographic data. The system may only read patent numbers and ignore other bibliographic data, or read both the patent numbers and other bibliographic data in order to compare them to the bibliographic data in the system for confirmation.

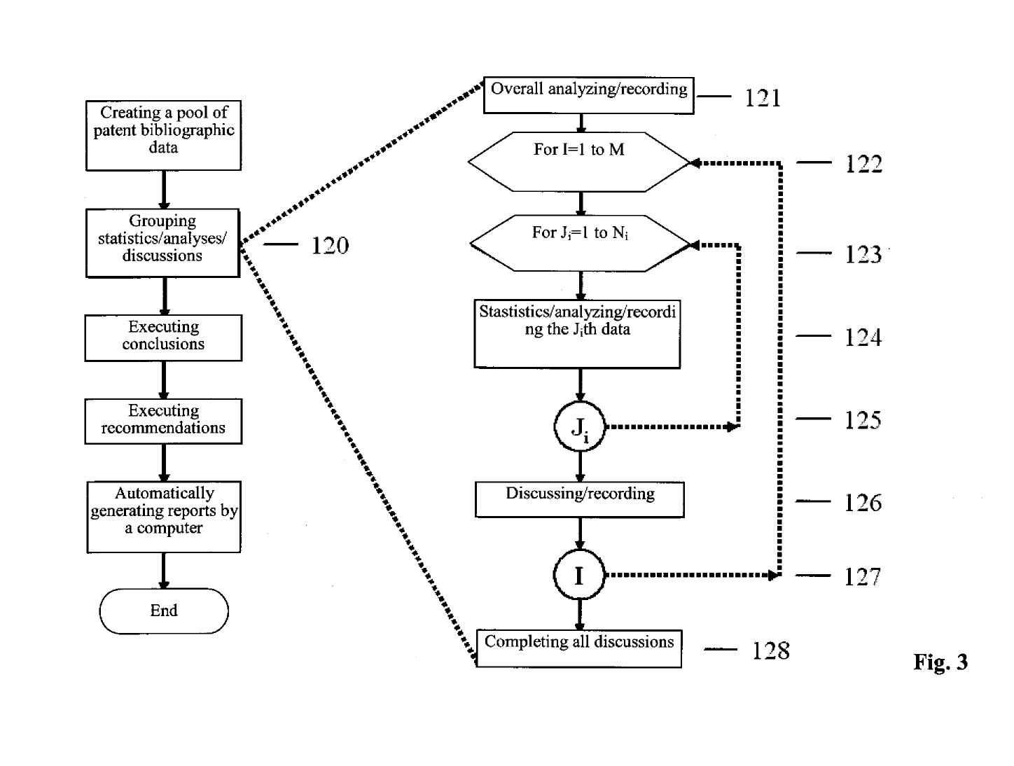

FIG. 3 shows an example of the step 120 according to the preferred embodiment of the invention from FIG. 1. Step 121 carries out statistics/analyses on all of the patent bibliographic data, and temporarily stores statistical results thereof in the memory, such as statistical/analytical items including: statistics/analyses of total historical patent numbers, total patent numbers related to life cycles, patent numbers for different countries, patent numbers for different assignees, patent numbers for different inventors . . . ; wherein steps 122, 123, 124, 125, 126, and 127 form a larger loop, and steps 123, 124, and 125 form a smaller loop within the larger loop, such that the larger loop and the smaller loop form a nested loop; the larger loop is used to: carry out statistics/analyses according to a sequence (I values) decided by grouped discussions. For example, if I=1, it means statistics/analyses for grouped discussions of different countries would be carried out, and if I=2, it means statistics/analyses for grouped discussions of different assignees would be carried out . . . etc; wherein M values represent the group number based on discussions; the smaller loop is used to: carry out grouped statistics/analyses according to a sequence of statistics/analyses of the grouped discussions, wherein Ni values represent the total statistical values of the Iₜₕ group (the N values of different groups are usually different). For instance, using the group of historical patent numbers for different countries (I=1) as an example, the country numbers (or important country numbers if necessary; total country numbers are generally used in order to execute the “recommendations” function, which is also used in this example) included in the patent pool can be found out from the statistics/analyses of total patent numbers of different countries in step 121; step 124 carries out statistics/analyses on individual sub-patent pools, and then records the statistical/analytical results, wherein said sub-patent pools is explained as follows: for instance, in the historical patent statistics for the U.S. (J₁=1) from the historical patent statistics of different countries (I=1), a sub-patent pool of the “US” is resulted from a patent group based on the country U.S. from the overall patent pool, and bibliographic data thereof then forms a sub-patent bibliographic data pool of the U.S. for further statistics/analyses, and the methods for said statistics/analyses are described above; step 126 carries out discussions on all of the statistical/analytical results for all groups, and the methods for said discussions are described above.

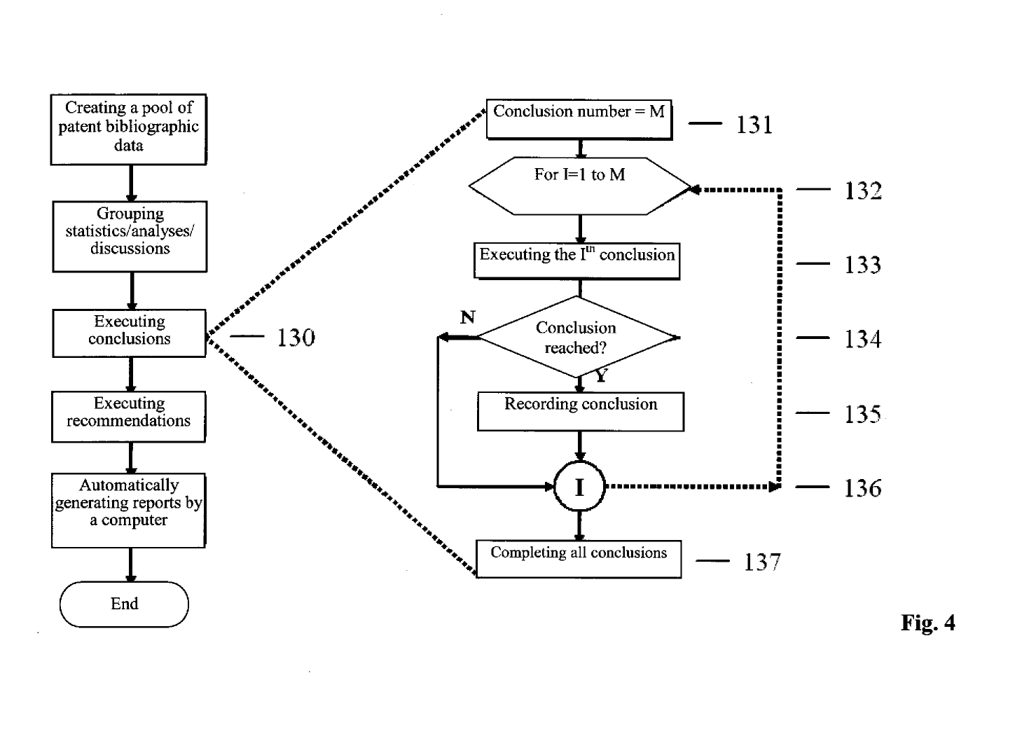

FIG. 4 shows an example of the step 130 according to the preferred embodiment of the invention from FIG. 1. Step 131 decides a conclusion number M, and a system default value is used in this example; steps 132, 133, 134, 135, and 136 form a conclusion loop, wherein step 133 makes conclusions according to a default method for each of the conclusions, and the methods for said conclusions are described above; step 134 executes a criterion, and executes step 135 if conclusions were reached, or skips step 135 if no conclusions were reached; step 137 completes conclusions so that the system can temporarily store all of the conclusions in the memory, before further executing step 140.

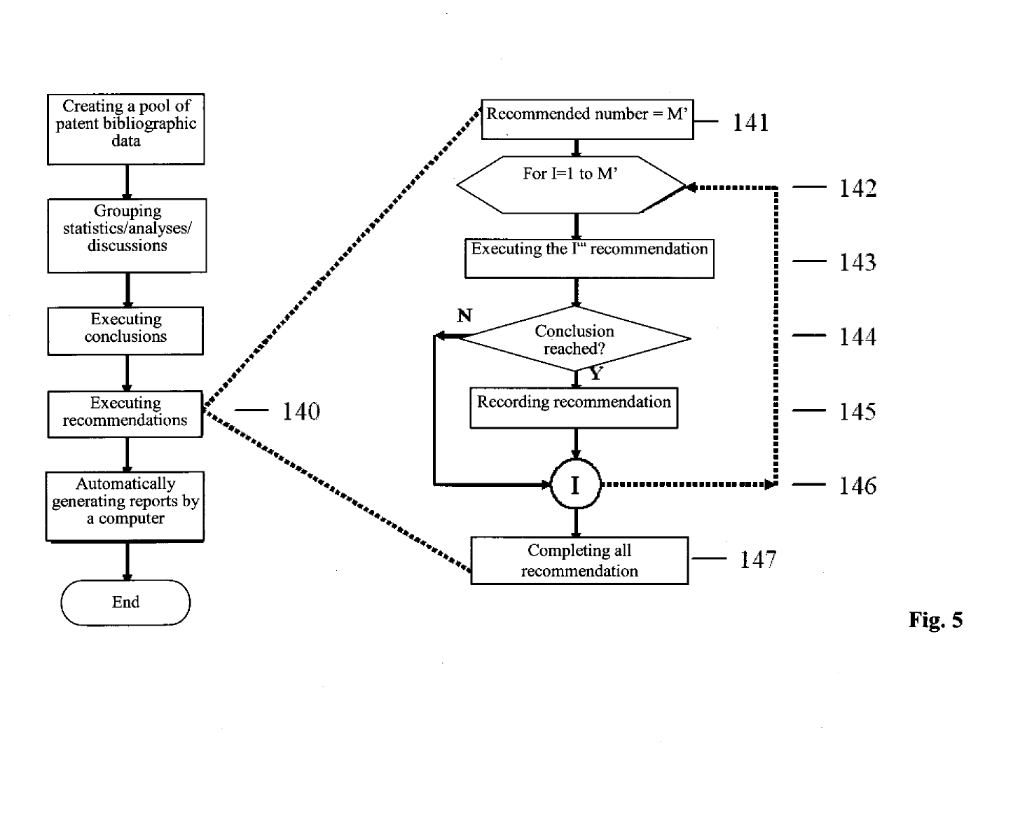

FIG. 5 shows an example of the step 140 according to the preferred embodiment of the invention from FIG. 1. Steps 141, 142, 143, 144, 145, 146, and 147 resemble the steps 131, 132, 133, 134, 135, 136, and 137, the only difference being that the steps 141, 142, 143, 144, 145, 146, and 147 are executed to reach conclusions, whereas the steps 131, 132, 133, 134, 135, 136, and 137 are executed to make recommendations.

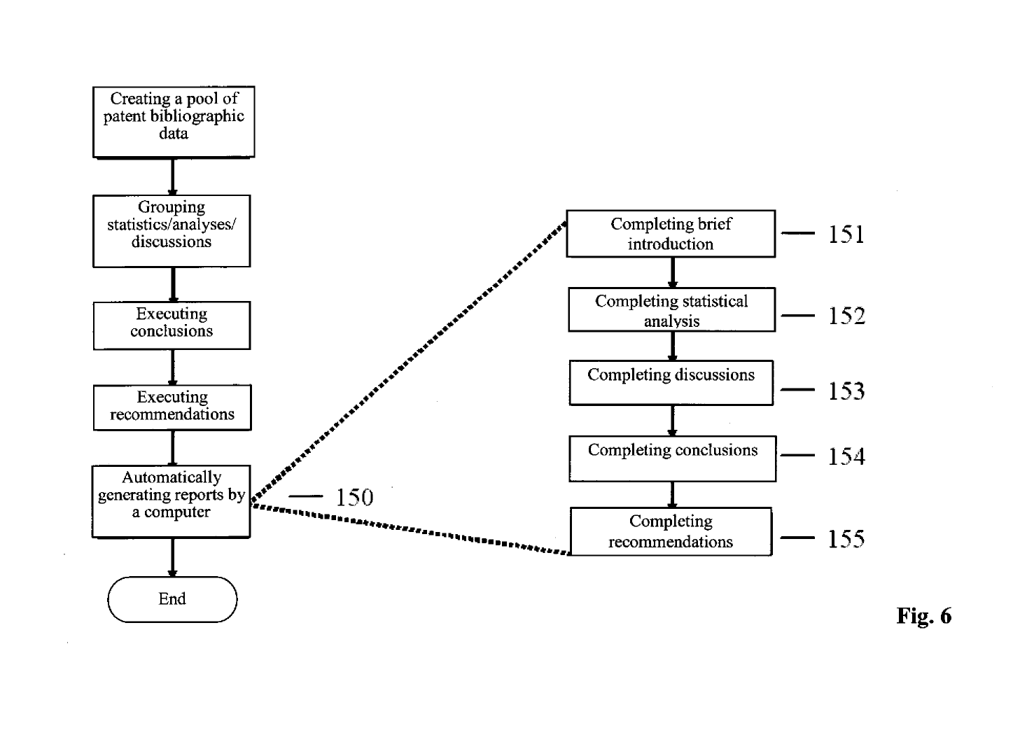

FIG. 6 shows an example of the step 150 according to the preferred embodiment of the invention from FIG. 1. Step 151 executes the writing of brief introductions (please refer to the paragraphs above about the related methods) and then stores them in a report file; step 152 reads statistical/analytical contents from the memory and stores them in the report file; step 153 reads discussions from the memory and stores them in the report file; step 154 reads conclusions from the memory and stores them in the report file; step 155 reads recommendations from the memory and stores them in the report file.

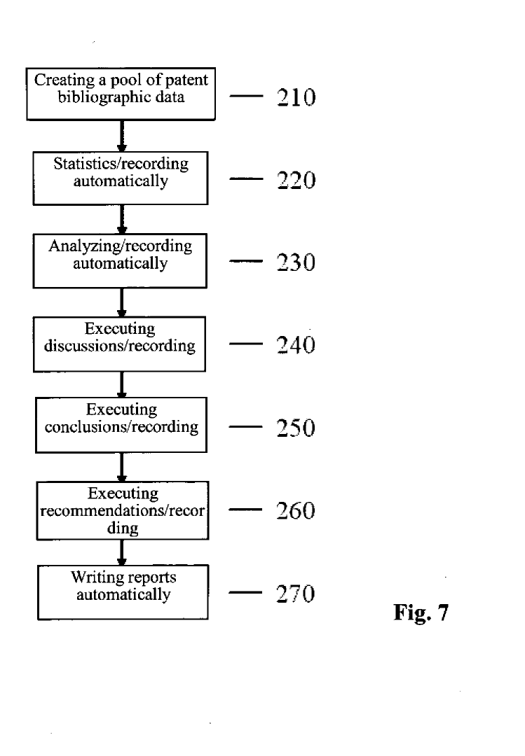

FIG. 7 shows the execution flowchart according to another preferred embodiment of the invention, wherein step 210 creates a pool of patent bibliographic data, and temporarily stores the pool in a memory; step 220 carries out grouped statistics on the patent bibliographic data from step 210, and then temporarily stores statistical results thereof in the memory; step 230 makes grouped analyses on the statistical results obtained in step 220, and temporarily stores analytical results thereof in the memory; step 240 makes grouped discussions on the analytical results obtained in step 230, and temporarily stores discussion results thereof in the memory; step 250 makes conclusions on the discussion results obtained in step 240, and temporarily stores conclusions thereof in the memory; step 260 makes recommendations on the discussion results obtained in step 240, and temporarily stores recommendations thereof in the memory; step 270 arranges a complete report from the statistics, analyses, discussions, conclusions, recommendations temporarily stored in the memory according to inputted information, and adds a brief introduction written according to the inputted information and the results of statistics/analyses/discussions thereto, and it is executed according to the method similar to FIG. 6 and descriptions thereof.

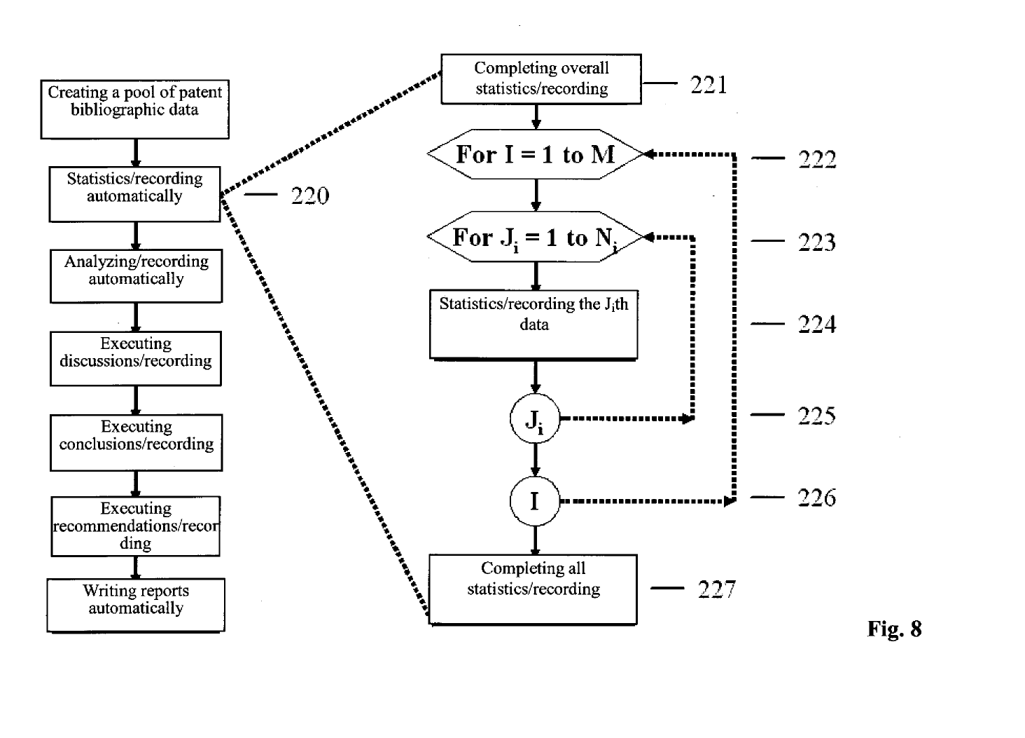

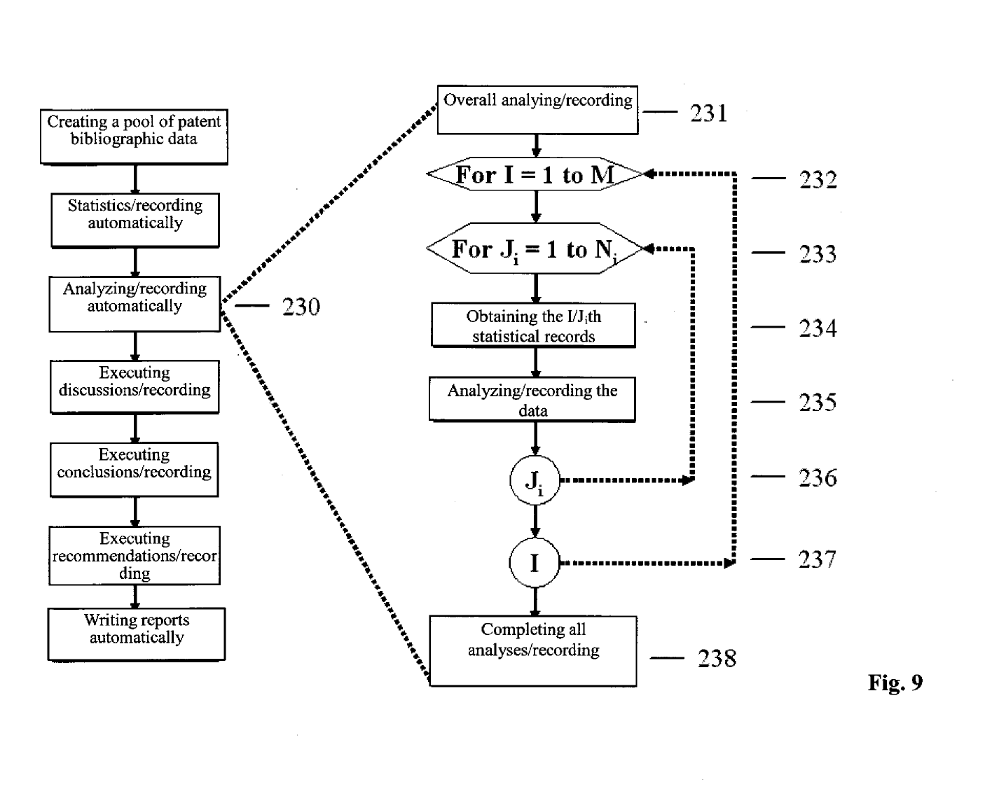

FIG. 8 shows an example of the step 220 according to the preferred embodiment of the invention from FIG. 7. Step 221 carries out statistics on all of the patent bibliographic data and temporarily stores them in the memory, the statistical items have been described in FIG. 3, wherein steps 222, 223, 224, 225, and 226 form a larger loop, and steps 223, 224, and 225 form a smaller loop within the larger loop, such that the larger loop and the smaller loop form a nested loop; in which 222, 223, 224, 225, and 226 respectively resemble the steps 122, 123, 124, 125, and 127 of FIG. 3, but step 224 only carries out statistics and recording (temporarily stores the statistical results in the memory), but does not analyze; step 227 completes all statistical results and further executes a step 230 (refer to FIG. 9 and descriptions thereof below).

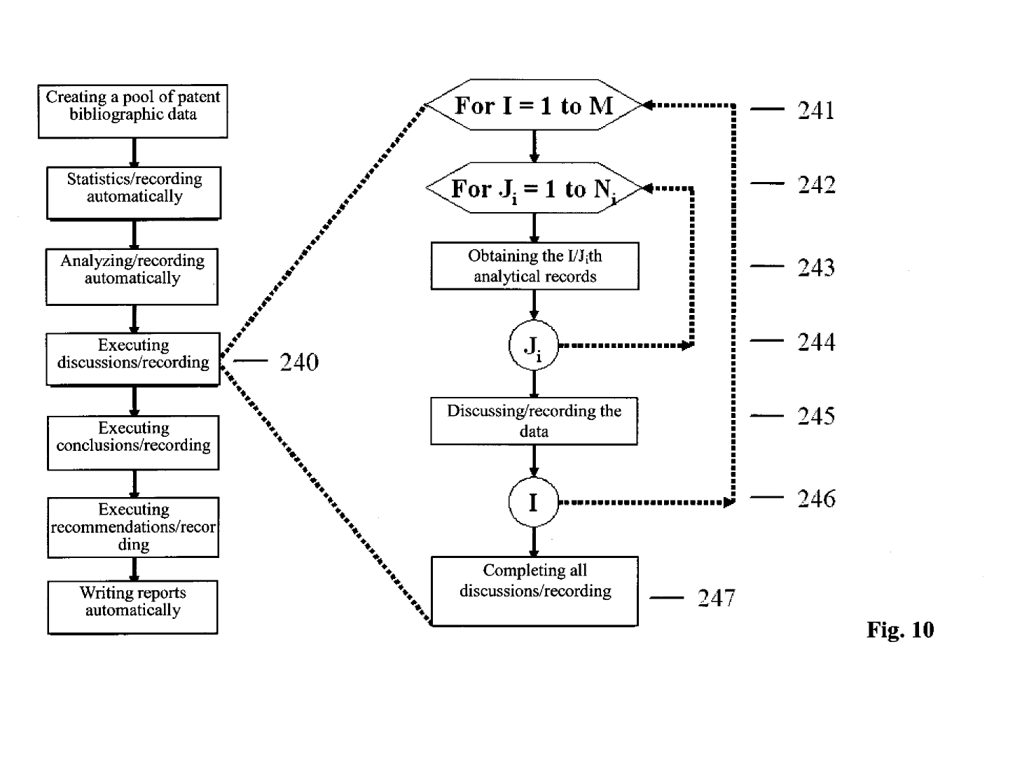

FIG. 9 shows an example of the step 230 according to the preferred embodiment of the invention from FIG. 7. Step 231 analyzes the overall statistical results, and the statistical results come from the analytical results shown in FIG. 8 (temporarily stored in the memory), the analytical items can be referred to in FIG. 3; in which steps 232, 233, 234, 235, 236, and 237 form a larger loop, and steps 233, 234, 235, and 236 form a smaller loop within the larger loop, such that the larger loop and the smaller loop form a nested loop; wherein steps 231, 232, 233, 236, and 237 respectively resemble the steps 121, 122, 123, 125, and 127 of FIG. 3, but step 235 only carries out analyses and recording (temporarily stores the analytical results in the memory), thus step 234 must be executed before analyzing so that the statistical results waiting for analysis can be retrieved from the memory; step 238 completes all analyses and further executes a step 240 (refer to FIG. 10 and descriptions thereof below).

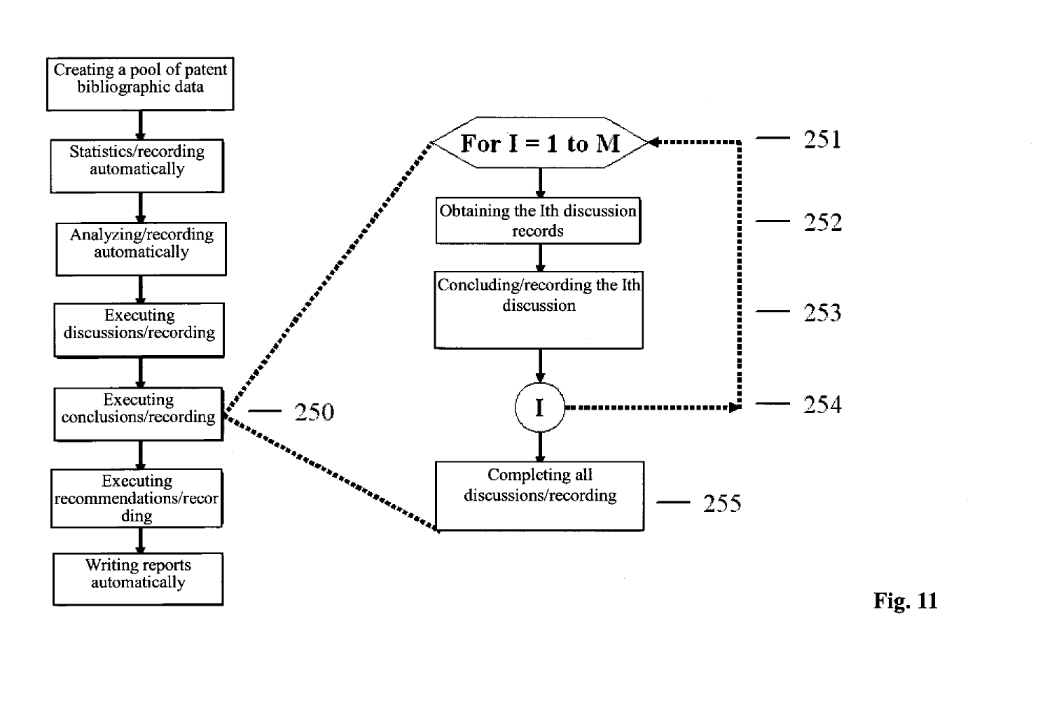

FIG. 10 shows an example of the step 240 according to the preferred embodiment of the invention from FIG. 7. Steps 241, 242, 243, 244, 245, and 246 form a larger loop, and steps 242, 243, and 244 form a smaller loop within the larger loop, such that the larger loop and the smaller loop form a nested loop; wherein steps 241, 242, 244, 245, 246, and 247 respectively resemble the steps 122, 123, 125, 126, 127, and 128 of FIG. 3. The analytical records of step 243 are obtained from the completed analytical results for the same I/J values in step 234 of FIG. 9. Step 247 completes all of the discussions, and further executes a step 250 (refer to FIG. 11 and descriptions thereof below).

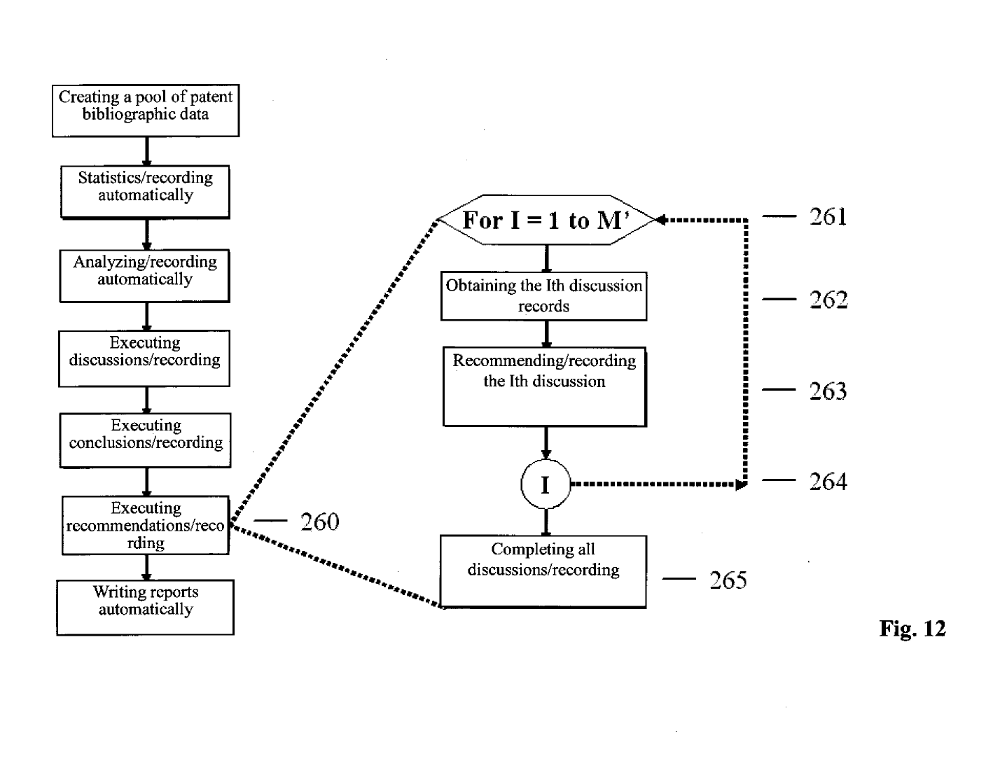

FIG. 11 shows an example of the step 250 according to the preferred embodiment of the invention from FIG. 7. Steps 251, 252, 253, and 254 form a conclusion loop; wherein step 252 obtains discussions of the same I values from step 245 of FIG. 10. Step 253 executes conclusions by basing on the discussions obtained in step 252. Step 255 completes conclusions so that the system can temporarily store all of the conclusions in the memory, and further executes a step 260 (refer to FIG. 12 and descriptions thereof below).

FIG. 12 shows an example of the step 260 according to the preferred embodiment of the invention from FIG. 7. Steps 261, 262, 263, and 264 form a recommendation loop; wherein step 262 obtains discussions of the same I values from step 245 of FIG. 10. Step 263 executes recommendations by basing on the discussions obtained in step 262. Step 265 completes recommendations so that the system can temporarily store all of the recommendations in the memory, and further executes a step 270.

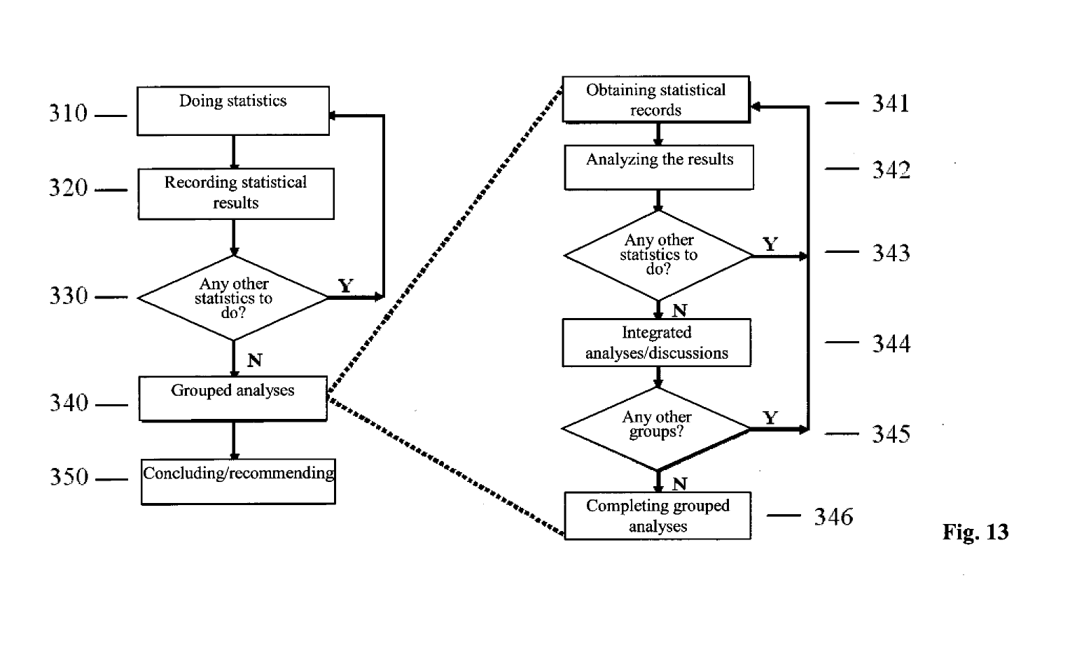

FIG. 13 shows the execution flowchart according to a further preferred embodiment of the invention, wherein step 310 carries out statistics on the patent bibliographic data from the pool of patent bibliographic data; step 320 temporarily stores the statistical results of patent bibliographic data from step 310 in the memory; step 330 is a conditional statement, if the statistics were not completed yet, then steps 310 and 320 would be continued; if all of the statistics were completed, then step 340 would be executed; step 340 carries out grouped analyses on all of the statistical results, using the analysis method shown in steps 341, 342, 343, 344, 345, and 346 of this diagram; step 350 executes conclusions and recommendations by basing on the analytical results of step 340; procedures of the automatic reports-generating step are not shown here. Steps 341, 342, 343, 344, 345, and 346 are the detailed procedures of the grouped analyses step (340), wherein step 341 obtains the required statistical results from step 320; step 342 analyzes the statistical results obtained in step 320; step 343 is a conditional statement; if the analyses of the groups were not finished yet, steps 341 and 342 would be repeated, if the analyses of the groups had been finished, then step 344 would be executed; step 344 makes discussions on the analyzed groups; step 353 is another conditional statement, if the analyses/discussions on some of the groups were not yet finished, steps 341, 342, 343, 344, and 345 would be repeated; if the analyses of the groups had been finished, this means the grouped analyses have been completed, and the automatic reports-generating step could then be executed (not shown in the diagram).

FIG. 14 shows a flowchart for evaluating the rationality of patent statistical analyses according to the invention. Wherein steps 810, 815, 820, 825, 830, 835, 840, 845, 850, and 855 form a larger loop; steps 820, 825, 830, 835, 840, 845, 850, and 855 form a smaller loop within the larger loop. The patent bibliographic data in step 800 is obtained from the patent pool by the computer directly; step 805 resets the error rate for each year to zero; step 815 obtains the patent bibliographic data for the 1st to the I−1ₜₕ year and use it as a basis for making prediction/evaluation for the statistical analysis rules; step 825 sequentially predicts values for the Iₜₕ year by basing on the patent bibliographic data obtained in step 815, and then compares the values to the actual data; if the errors did not exceed a default value, the smaller loop would be executed, if the errors exceeded the default value, then the conditional statement 835 would be executed; if there was a reason for the errors exceeding the default value, then step 840 would be executed to record the exceptions, if there wasn't a reason for the errors exceeding the default value, then step 845 would be executed, in which 1 would be added to the error value for the year and then the larger loop executed; if any of the statistics/analyses had prediction error values exceeding a default value more than a certain degree (the current system default value is 15%), then the results of the statistics/analyses would be listed as “undetermined”. For example, in the following Embodiment 1, 13 out of the 160 items of statistics/analyses for historical patent numbers are listed as “undetermined”. These items would be included into system review files for making new statistical/analytical rules, or modifying existing statistical/analytical rules once more figures had been accumulated in the future.

FIG. 15 shows a flowchart for evaluating the rationality of integrated analytical results according to the invention. Step 900 obtains an item of the maximum number (I); for instance, in Embodiment 1, “maturing period” has 124 matching statistical items and is acquired; step 910 obtains a weighted value Wi for the item and in Embodiment 1, Wi=15.05; step 920 adds up the weighted values to give a sum Wt, refer to Embodiment 1:

Wt=0.01+0.1+15.05+0.29+0.37=15.82

Step 930 calculates a weighted ratio R, refer to Embodiment 1:

R=15.05/15.82=0.951

Step 940 is a conditional statement; if the R value was less than 0.9, step 950 would be executed (the items would be included into the system review figures for making new integrated analyses rules, or modifying existing integrated analyses rules once more figures had been accumulated in the future), otherwise step 960 would be executed. In Embodiment 1, the R value is 0.951, thus step 960 is executed; step 960 executes conclusions, and the conclusion in Embodiment 1 determines that the technology life cycle is in the “maturing period”.

### Embodiment 1

5326 US patents related to kinase between the years of 1984 to 2004 are used for automatic statistical analyses, and hundreds of statistical results have been obtained, and the analytical report includes a lot of information. For example, considering the statistical analyses for historical patent numbers alone, 160 statistical tables were obtained (the data are omitted in this application), and a computer was used to analyze the data, and list the data in a table to serve as a basis for investigating the life cycle for the technology, which is also the discussion part for the item as follows:

### Historical Patent Number Analysis

| | | |
|---|---|---|
| | | Weighted |
| Table name | Period | value |

Histogram analysis based on the nationalities of assignees:

| | | | |
|---|---|---|---|
| 1 | Historical patent number analysis for US | maturing | 71.20% |
| 2 | Historical patent number analysis for JP | maturing | 6.85% |
| 3 | Historical patent number analysis for None | growing | 6.76% |
| 4 | Historical patent number analysis for GB | maturing | 3.29% |
| 5 | Historical patent number analysis for FR | maturing | 1.75% |
| 6 | Historical patent number analysis for DE | undetermined | 1.58% |
| 7 | Historical patent number analysis for CH | maturing | 1.03% |

Histogram analysis based on the main assignees:

| | | | |
|---|---|---|---|
| 1 | Historical patent number analysis for SmithKline | maturing | 1.22% |
| | Beecham Corporation | | |
| 2 | Historical patent number analysis for the Regents of | declining | 1.18% |
| | the University of California | | |
| 3 | Historical patent number analysis for Sugen, Inc. | growing | 0.75% |
| 4 | Historical patent number analysis for Merck & Co., | undetermined | 0.73% |
| | Inc. | | |
| 5 | Historical patent number analysis for Eli Lilly and | growing | 0.69% |
| | Company | | |
| 6 | Historical patent number analysis for Board of | undetermined | 0.58% |
| | Regents, the University of Texas System | | |
| 7 | Historical patent number analysis for Bristol-Myers | maturing | 0.56% |
| | Squibb Company | | |
| 8 | Historical patent number analysis for the United | maturing | 0.54% |
| | States of America as represented by the Department | | |
| | of Health and Human Services | | |
| 9 | Historical patent number analysis for Genentech, Inc. | declining | 0.53% |
| 10 | Historical patent number analysis for Millennium | sprouting | 0.53% |
| | Pharmaceuticals, Inc. | | |
| 11 | Historical patent number analysis for Chiron | sprouting | 0.51% |
| | Corporation | | |
| 12 | Historical patent number analysis for Hoffmann-La | undetermined | 0.51% |
| | Roche Inc. | | |
| 13 | Historical patent number analysis for Pfizer Inc. | maturing | 0.51% |
| 14 | Historical patent number analysis for the General | undetermined | 0.49% |
| | Hospital Corporation | | |
| 15 | Historical patent number analysis for Isis Pharmaceuticals Inc. | sprouting | 0.45% |

Histogram analysis based on all three orders of MIPC:

| | | | |
|---|---|---|---|
| 1 | Historical patent number analysis for A61K | maturing | 34.42% |
| 2 | Historical patent number analysis for C12Q | maturing | 15.19% |
| 3 | Historical patent number analysis for C12N | peak | 14.68% |
| 4 | Historical patent number analysis for G01N | maturing | 7.29% |
| 5 | Historical patent number analysis for C12P | maturing | 6.89% |
| 6 | Historical patent number analysis for C07D | maturing | 5.46% |
| 7 | Historical patent number analysis for C07K | peak | 3.30% |

Histogram analysis based on all four orders of MIPC:

| | | | |
|---|---|---|---|
| 1 | Historical patent number analysis for A61K031 | maturing | 17.41% |
| 2 | Historical patent number analysis for C12Q001 | maturing | 15.13% |
| 3 | Historical patent number analysis for G01N033 | maturing | 6.83% |
| 4 | Historical patent number analysis for A61K038 | maturing | 5.56% |
| 5 | Historical patent number analysis for C12N009 | maturing | 5.31% |
| 6 | Historical patent number analysis for C12N015 | declining | 5.22% |
| 7 | Historical patent number analysis for A61K048 | maturing | 4.36% |
| 8 | Historical patent number analysis for C12P021 | declining | 3.12% |
| 9 | Historical patent number analysis for A61K039 | maturing | 2.82% |
| 10 | Historical patent number analysis for C07H021 | maturing | 2.53% |
| 11 | Historical patent number analysis for C12N005 | undetermined | 2.12% |

Histogram analysis based on all five orders of MIPC:

| | | | |
|---|---|---|---|
| 1 | Historical patent number analysis for C12Q001/68 | maturing | 8.17% |
| 2 | Historical patent number analysis for A61K048/0 | maturing | 4.36% |
| 3 | Historical patent number analysis for G01N033/53 | maturing | 3.70% |
| 4 | Historical patent number analysis for C12N009/12 | maturing | 3.21% |
| 5 | Historical patent number analysis for C07H021/4 | maturing | 1.76% |
| 6 | Historical patent number analysis for A61K039/395 | maturing | 1.71% |
| 7 | Historical patent number analysis for C12Q001/48 | maturing | 1.67% |
| 8 | Historical patent number analysis for C12N015/0 | undetermined | 1.46% |
| 9 | Historical patent number analysis for C12Q001/0 | declining | 1.33% |
| 10 | Historical patent number analysis for C12P021/6 | declining | 1.31% |
| 11 | Historical patent number analysis for A61K038/17 | growing | 1.20% |
| 12 | Historical patent number analysis for C12P021/2 | undetermined | 1.01% |
| 13 | Historical patent number analysis for A61K038/0 | undetermined | 0.92% |
| 14 | Historical patent number analysis for A61K031/505 | undetermined | 0.90% |
| 15 | Historical patent number analysis for C12P013/8 | growing | 0.90% |

Histogram analysis based on all three orders of CRIPC:

| | | | |
|---|---|---|---|
| 1 | Historical patent number analysis for C12N | maturing | 30.64% |
| 2 | Historical patent number analysis for A61K | maturing | 24.39% |
| 3 | Historical patent number analysis for C07H | maturing | 15.43% |
| 4 | Historical patent number analysis for C07D | maturing | 11.70% |
| 5 | Historical patent number analysis for C12P | maturing | 10.53% |
| 6 | Historical patent number analysis for G01N | maturing | 9.56% |
| 7 | Historical patent number analysis for C12Q | maturing | 9.20% |

Histogram analysis based on all four orders of CRIPC:

| | | | |
|---|---|---|---|
| 1 | Historical patent number analysis for C12N015 | maturing | 16.73% |
| 2 | Historical patent number analysis for A61K031 | maturing | 14.78% |
| 3 | Historical patent number analysis for C07H021 | maturing | 14.57% |
| 4 | Historical patent number analysis for C12N009 | maturing | 9.54% |
| 5 | Historical patent number analysis for C12N005 | maturing | 9.50% |
| 6 | Historical patent number analysis for C12Q001 | maturing | 9.13% |
| 7 | Historical patent number analysis for G01N033 | maturing | 9.09% |
| 8 | Historical patent number analysis for C12P021 | maturing | 7.57% |

Histogram analysis based on all five orders of CRIPC:

| | | | |
|---|---|---|---|
| 1 | Historical patent number analysis for C07H021/4 | maturing | 13.37% |
| 2 | Historical patent number analysis for C12N015/0 | maturing | 5.56% |
| 3 | Historical patent number analysis for C12P021/2 | maturing | 5.01% |
| 4 | Historical patent number analysis for C12N009/12 | maturing | 4.17% |
| 5 | Historical patent number analysis for C12N005/6 | maturing | 4.09% |
| 6 | Historical patent number analysis for C12Q001/68 | maturing | 4.00% |
| 7 | Historical patent number analysis for G01N033/53 | maturing | 3.29% |
| 8 | Historical patent number analysis for C12N015/63 | declining | 3.08% |
| 9 | Historical patent number analysis for C12N001/21 | maturing | 2.84% |
| 10 | Historical patent number analysis for C12N001/20 | declining | 2.76% |

Histogram analysis based on all three orders of TIPC:

| | | | |
|---|---|---|---|
| 1 | Historical patent number analysis for A61K | maturing | 44.54% |
| 2 | Historical patent number analysis for C12N | maturing | 35.49% |
| 3 | Historical patent number analysis for C12Q | maturing | 20.65% |
| 4 | Historical patent number analysis for C07H | maturing | 17.82% |
| 5 | Historical patent number analysis for C12P | maturing | 15.23% |
| 6 | Historical patent number analysis for C07D | maturing | 14.70% |
| 7 | Historical patent number analysis for G01N | maturing | 13.54% |

Histogram analysis based on all four orders of TIPC:

| | | | |
|---|---|---|---|
| 1 | Historical patent number analysis for A61K031 | maturing | 24.80% |
| 2 | Historical patent number analysis for C12Q001 | maturing | 20.60% |
| 3 | Historical patent number analysis for C12N015 | maturing | 19.28% |
| 4 | Historical patent number analysis for C07H021 | maturing | 16.60% |
| 5 | Historical patent number analysis for C12N009 | maturing | 14.06% |
| 6 | Historical patent number analysis for G01N033 | maturing | 12.81% |
| 7 | Historical patent number analysis for C12N005 | maturing | 11.32% |
| 8 | Historical patent number analysis for C12P021 | maturing | 10.29% |
| 9 | Historical patent number analysis for A61K038 | maturing | 8.62% |

Histogram analysis based on all five orders of TIPC:

| | | | |
|---|---|---|---|
| 1 | Historical patent number analysis for C07H021/4 | maturing | 15.13% |
| 2 | Historical patent number analysis for C12Q001/68 | maturing | 12.17% |
| 3 | Historical patent number analysis for C12N009/12 | maturing | 7.38% |
| 4 | Historical patent number analysis for C12N015/0 | declining | 7.02% |
| 5 | Historical patent number analysis for G01N033/53 | maturing | 6.98% |
| 6 | Historical patent number analysis for C12P021/2 | maturing | 6.03% |
| 7 | Historical patent number analysis for A61K048/0 | maturing | 5.82% |
| 8 | Historical patent number analysis for C12N005/6 | maturing | 4.36% |
| 9 | Historical patent number analysis for C12N015/63 | undetermined | 3.70% |
| 10 | Historical patent number analysis for C12N001/20 | maturing | 3.45% |
| 11 | Historical patent number analysis for C12Q001/48 | undetermined | 3.40% |
| 12 | Historical patent number analysis for C12N005/0 | maturing | 3.30% |
| 13 | Historical patent number analysis for C12N001/21 | maturing | 3.12% |
| 14 | Historical patent number analysis for A61K039/395 | maturing | 3.02% |
| 15 | Historical patent number analysis for C12P021/6 | maturing | 2.74% |

Histogram analysis based on all one order of MUPC:

| | | | |
|---|---|---|---|
| 1 | Historical patent number analysis for 435 | maturing | 43.54% |
| 2 | Historical patent number analysis for 514 | maturing | 28.73% |
| 3 | Historical patent number analysis for 424 | maturing | 11.94% |
| 4 | Historical patent number analysis for 800 | maturing | 3.15% |
| 5 | Historical patent number analysis for 530 | maturing | 2.76% |
| 6 | Historical patent number analysis for 536 | maturing | 2.40% |
| 7 | Historical patent number analysis for 544 | maturing | 1.00% |
| 8 | Historical patent number analysis for 604 | maturing | 0.88% |

Histogram analysis based on all two orders of MUPC:

| | | | |
|---|---|---|---|
| 1 | Historical patent number analysis for 435/006 | maturing | 7.90% |
| 2 | Historical patent number analysis for 435/007 | maturing | 6.40% |
| 3 | Historical patent number analysis for 435/069 | declining | 4.86% |
| 4 | Historical patent number analysis for 435/194 | undetermined | 3.42% |
| 5 | Historical patent number analysis for 514/044 | maturing | 2.93% |
| 6 | Historical patent number analysis for 424/093 | maturing | 2.35% |
| 7 | Historical patent number analysis for 424/094 | maturing | 2.33% |
| 8 | Historical patent number analysis for 514/012 | maturing | 2.14% |
| 9 | Historical patent number analysis for 435/015 | maturing | 1.90% |

Histogram analysis based on all one order of CRUPC:

| | | | |
|---|---|---|---|
| 1 | Historical patent number analysis for 435 | maturing | 51.45% |
| 2 | Historical patent number analysis for 536 | maturing | 24.84% |
| 3 | Historical patent number analysis for 514 | maturing | 24.45% |
| 4 | Historical patent number analysis for 530 | maturing | 13.82% |
| 5 | Historical patent number analysis for 424 | maturing | 13.03% |
| 6 | Historical patent number analysis for 544 | maturing | 9.33% |
| 7 | Historical patent number analysis for 546 | maturing | 6.76% |
| 8 | Historical patent number analysis for 436 | peak | 5.46% |

Histogram analysis based on all two orders of CRUPC:

| | | | |
|---|---|---|---|
| 1 | Historical patent number analysis for 536/023 | maturing | 21.80% |
| 2 | Historical patent number analysis for 435/320 | maturing | 20.56% |
| 3 | Historical patent number analysis for 435/069 | maturing | 13.01% |
| 4 | Historical patent number analysis for 435/325 | maturing | 11.70% |
| 5 | Historical patent number analysis for 435/252 | maturing | 10.16% |
| 6 | Historical patent number analysis for 435/007 | maturing | 8.64% |
| 7 | Historical patent number analysis for 435/006 | maturing | 6.44% |
| 8 | Historical patent number analysis for 530/350 | maturing | 6.37% |
| 9 | Historical patent number analysis for 536/024 | declining | 6.16% |

Histogram analysis based on all one order of TUPC:

| | | | |
|---|---|---|---|
| 1 | Historical patent number analysis for 435 | maturing | 58.60% |
| 2 | Historical patent number analysis for 514 | maturing | 36.65% |
| 3 | Historical patent number analysis for 536 | maturing | 26.15% |
| 4 | Historical patent number analysis for 424 | maturing | 18.89% |
| 5 | Historical patent number analysis for 530 | maturing | 15.00% |
| 6 | Historical patent number analysis for 544 | maturing | 9.67% |
| 7 | Historical patent number analysis for 546 | maturing | 6.95% |
| 8 | Historical patent number analysis for 436 | peak | 5.75% |

Histogram analysis based on all two orders of TUPC:

| | | | |
|---|---|---|---|
| 1 | Historical patent number analysis for 536/023 | maturing | 22.98% |
| 2 | Historical patent number analysis for 435/320 | maturing | 21.80% |
| 3 | Historical patent number analysis for 435/069 | maturing | 16.75% |
| 4 | Historical patent number analysis for 435/006 | maturing | 14.34% |
| 5 | Historical patent number analysis for 435/325 | maturing | 12.60% |
| 6 | Historical patent number analysis for 435/007 | maturing | 12.17% |
| 7 | Historical patent number analysis for 435/252 | maturing | 10.91% |

1. Overall Analysis for Different Periods of Historical Patent Number Analysis

| Period | Numbers | Total weighted value |
|---|---|---|
| Undetermined | 13 | 0.21 |
| Sprouting | 3 | 0.01 |
| Growing | 5 | 0.1 |
| Maturing | 124 | 15.05 |
| Peak | 4 | 0.29 |
| Declining | 11 | 0.37 |

According to said discussions, the computer then automatically generates a conclusion as follows (please refer to FIG. 15 and a description thereof):

“An integrated evaluation of the analytical results of different technology life cycles indicate that the technology is possibly in the maturing period.”

What is claimed is:

1. A method for automatically generating analytical reports of patent bibliographic data comprising:
a statistical step for patent bibliographic data, which implements statistical investigation on patent bibliographic data of specific patents;
an analytical step for the patent bibliographic data, which analyzes statistical results from the aforesaid statistical step;
characterized in that:
further comprising a reports-generating step, which converts the statistical and/or analytical results into analytical reports; and
the statistical step, the analytical step, and the reports-generating step are automatically generated by an automated apparatus.

2. The method of claim 1, wherein the reports-generating step comprises a secondary step of completing contents of statistics/analyses, or the analytical step for the patent bibliographic data comprises secondary steps of an integrated analyses and discussions, wherein said secondary step of completing contents of statistics/analyses combines results from the analytical step for the patent bibliographic data to form contents of statistics/analyses in the analytical reports; said secondary step of integrated analyses combines multiple analytical results into a discussion group, and do statistics/analyze similarity of the multiple analytical results of the group; said secondary step of discussions discusses results from integrated statistics/analyses, so as to obtain a basis for discussions of the analytical reports, and the secondary steps of completing contents of statistics/analyses, integrated analyses and discussions are executed by an automated apparatus.

3. The method of claim 2, wherein the reports-generating step further comprises a secondary step of completing discussions which combine an integrated statistical/analyses results from the secondary step of integrated analyses and/or discussion results form the secondary step of discussions to form integrated analytical contents and/or discussion results in the analytical reports, and the secondary step of completing discussions is executed by an automated apparatus.

4. The method of claim 2, wherein the analytical step for the patent bibliographic data comprises secondary steps of conclusion and/or recommendation, wherein the secondary step of conclusion makes conclusions based on results of the integrated statistics/analyses and/or results of the discussions; and the secondary step of recommendation makes recommendations based on results of the integrated statistics/analyses and/or results of the discussions, and the secondary steps of conclusion and recommendation are executed by an automated apparatus.

5. The method of claim 2, wherein the reports-generating step comprises secondary steps of completing conclusions and/or recommendations, wherein the secondary step of completing conclusions combines results of the integrated statistics/analyses and/or results of the discussions to form contents of conclusions in the analytical reports; and the secondary step of completing recommendations combines results of the integrated statistics/analyses and/or results of the discussions to form contents of recommendations in the analytical reports, and the secondary steps of completing conclusions and recommendations are executed by an automated apparatus.

6. The method of claim 1 further comprising a language selection step which allows a user to select a language in which the analytical reports are presented.

7. The method of claim 1, wherein the automated apparatus is a computer.

8. A system for automatically analyzing patent bibliographic data comprising:
an automated apparatus; and
a software application for automatically analyzing patent bibliographic data, such that said automated apparatus can automatically do statistics/analyses to patent bibliographic data waiting for analysis, and automatically generate analytical reports of patent bibliographic data thereafter;
characterized in that:
the software application comprises:
a statistical step, which implements statistical investigation on patent bibliographic data of specific patents;
an analytical step, which analyzes statistical results from said statistical step;
a reports-generating step, which converts the statistical and/or analytical results into analytical reports; and
said statistical step, said analytical step, and said reports-generating step are automatically generated by said automated apparatus.

9. The system of claim 8, wherein the reports-generating step comprises a secondary step of completing contents of statistics/analyses, or the analytical step for the patent bibliographic data comprises secondary steps of an integrated analyses and discussions, wherein said secondary step of completing contents of statistics/analyses combines results from the analytical step for the patent bibliographic data to form contents of statistics/analyses in the analytical reports; said secondary step of integrated analyses combines multiple analytical results into a discussion group, and do statistics/analyze similarity of the multiple analytical results of the group; said secondary step of discussions discusses results from integrated statistics/analyses, so as to obtain a basis for discussions of the analytical reports, and the secondary steps of completing contents of statistics/analyses, integrated analyses and discussions are executed by an automated apparatus.

10. The system of claim 9, wherein the reports-generating step further comprises a secondary step of completing discussions which combine an integrated statistical/analyses results from the secondary step of integrated analyses and/or discussion results form the secondary step of discussions to form integrated analytical contents and/or discussion results in the analytical reports, and the secondary step of completing discussions is executed by an automated apparatus.

11. The system of claim 9, wherein the analytical step for the patent bibliographic data comprises secondary steps of conclusion and/or recommendation, wherein the secondary step of conclusion makes conclusions based on results of the integrated statistics/analyses and/or results of the discussions; and the secondary step of recommendation makes recommendations based on results of the integrated statistics/analyses and/or results of the discussions, and the secondary steps of conclusion and recommendation are executed by an automated apparatus.

12. The system of claim 9, wherein the reports-generating step comprises secondary steps of completing conclusions and/or recommendations, wherein the secondary step of completing conclusions combines results of the integrated statistics/analyses and/or results of the discussions to form contents of conclusions in the analytical reports; and the secondary step of completing recommendations combines results of the integrated statistics/analyses and/or results of the discussions to form contents of recommendations in the analytical reports, and the secondary steps of completing conclusions and recommendations are executed by an automated apparatus.

13. The system of claim 8, wherein the software application further comprises a language selection step which allows a user to select a language in which the analytical reports are presented.

14. The system of claim 8, wherein the automated apparatus is a computer.

15. A computer storage medium for storing application commands for allowing an automated system to automatically analyze patent bibliographic data, and the application commands allow for automatic analysis of patent bibliographic data by comprising:
a statistical step, which implements statistical investigation on patent bibliographic data of specific patents;
an analytical step, which analyzes the statistical results from the aforesaid statistical step;
characterized in that:
further comprising a reports-generating step, which converts the statistical and/or analytical results into analytical reports.

16. The computer storage medium of claim 15, wherein the reports-generating step comprises a secondary step of completing contents of statistics/analyses, or the analytical step for the patent bibliographic data comprises secondary steps of an integrated analyses and discussions, wherein said secondary step of completing contents of statistics/analyses combines results from the analytical step for the patent bibliographic data to form contents of statistics/analyses in the analytical reports; said secondary step of integrated analyses combines multiple analytical results into a discussion group, and do statistics/analyze similarity of the multiple analytical results of the group; said secondary step of discussions discusses results from integrated statistics/analyses, so as to obtain a basis for discussions of the analytical reports, and the secondary steps of completing contents of statistics/analyses, integrated analyses and discussions are executed by an automated apparatus.

17. The computer storage medium of claim 16, wherein the reports-generating step further comprises a secondary step of completing discussions which combine an integrated statistical/analyses results from the secondary step of integrated analyses and/or discussion results form the secondary step of discussions to form integrated analytical contents and/or discussion results in the analytical reports, and the secondary step of completing discussions is executed by an automated apparatus.

18. The computer storage medium of claim 16, wherein the analytical step for the patent bibliographic data comprises secondary steps of conclusion and/or recommendation, wherein the secondary step of conclusion makes conclusions based on results of the integrated statistics/analyses and/or results of the discussions; and the secondary step of recommendation makes recommendations based on results of the integrated statistics/analyses and/or results of the discussions, and the secondary steps of conclusion and recommendation are executed by an automated apparatus.

19. The computer storage medium of claim 16, wherein the reports-generating step comprises secondary steps of completing conclusions and/or recommendations, wherein the secondary step of completing conclusions combines results of the integrated statistics/analyses and/or results of the discussions to form contents of conclusions in the analytical reports; and the secondary step of completing recommendations combines results of the integrated statistics/analyses and/or results of the discussions to form contents of recommendations in the analytical reports, and the secondary steps of completing conclusions and recommendations are executed by an automated apparatus.

20. The computer storage medium of claim 15, wherein the application commands further comprise a language selection step which allows a user to select a language in which the analytical reports are presented.

21. The computer storage medium of claim 15, wherein the automated apparatus is a computer.
